(19) United States
(12) Patent Application Publication
(10) Pub. No.: US 2015/0206440 A1
(43) Pub. Date: Jul. 23, 2015

(54) COMPUTING SYSTEM WITH LEARNING PLATFORM MECHANISM AND METHOD OF OPERATION THEREOF

(71) Applicant: Samsung Electronics Co., Ltd., Suwon-si (KR)

(72) Inventors: William Aylesworth, Santa Clara, CA (US); Tom Brinck, Palo Alto, CA (US)

(73) Assignee: Samsung Electronics Co., Ltd., Suwon-si (KR)

(21) Appl. No.: 14/160,372

(22) Filed: Jan. 21, 2014

(51) Int. Cl. G09B 5/00; G06Q 50/20; G09B 7/00

(52) U.S. Cl. CPC G09B 5/00; G09B 7/00; G06Q 50/20

(57) ABSTRACT

A computing system includes: a learner analysis module configured to determine a learner profile; a lesson module, coupled to the learner analysis module, configured to identify a learner response for an assessment component for a subject matter corresponding to the learner profile; an observation module, coupled to the learner analysis module, configured to determine a response evaluation factor associated with the learner response; and a knowledge evaluation module, coupled to the observation module, configured to generate a learner knowledge model including a mastery level based on the learner response, the response evaluation factor, and the learner profile for displaying on a device.

### CROSS-REFERENCE TO RELATED APPLICATION

This application claims the benefit of U.S. Provisional Patent Application Ser. No. 61/819,310 filed May 3, 2013, and the subject matter thereof is incorporated herein by reference thereto.

### TECHNICAL FIELD

An embodiment of the present invention relates generally to a computing system, and more particularly to a system for teaching and learning.

### BACKGROUND

Modern consumer and industrial electronics, such as computing systems, televisions, tablets, cellular phones, portable digital assistants, projectors, and combination devices, are providing increasing levels of functionality to support modern life. In addition to the explosion of functionality and proliferation of these devices into the everyday life, there is also an explosion of data and information being created, transported, consumed, and stored.

The increasing availability of information in modern life requires users to process ever increasing amounts of information for the purpose of learning. The increased availability creates heavier demand on managing information for the purposes of teaching, learning, and mastering knowledge.

Thus, a need still remains for a computing system with learning platform mechanism for optimizing the available information for the purpose of teaching or learning. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: a learner analysis module configured to determine a learner profile; a lesson module, coupled to the learner analysis module, configured to identify a learner response for an assessment component for a subject matter corresponding to the learner profile; an observation module, coupled to the learner analysis module, configured to determine a response evaluation factor associated with the learner response; and a knowledge evaluation module, coupled to the observation module, configured to generate a learner knowledge model including a mastery level based on the learner response, the response evaluation factor, and the learner profile for displaying on a device.

An embodiment of the present invention provides a method of operation of a computing system including: determining a learner profile; identifying a learner response for an assessment component for a subject matter corresponding to the learner profile; determining a response evaluation factor associated with the learner response; and generating a learner knowledge model including a mastery level based on the learner response, the response evaluation factor, and the learner profile for displaying on a device.

An embodiment of the present invention provides a graphic user interface to exchange dynamic information related to a subject matter, the graphic user interface displayed on an user interface of a device including: a profile portion configured to display a learner profile; a lesson portion configured to receive a learner response for an assessment component and receive a response evaluation factor associated with the learner response; and a knowledge model portion configured to present a learner knowledge model including a mastery level based on updates to the profile portion and the lesson portion.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with learning platform mechanism in an embodiment of the present invention.

FIG. 2 is an example display of the first device.

FIG. 3 is a further example display of the first device.

FIG. 4 is a further example display of the first device.

FIG. 5 is a functional block diagram of the computing system.

FIG. 6 is a further functional block diagram of the computing system.

FIG. 7 is a control flow of the computing system.

FIG. 8 is a detailed view of the identification module and the assessment module.

FIG. 9 is a detailed view of the assessment module.

FIG. 10 is a detailed view of the planning module.

FIG. 11 is a detailed view of the style module.

FIG. 12 is a detailed view of the community module.

FIG. 13 is a detailed view of the contributor evaluation module.

FIG. 14 is a detailed view of the knowledge evaluation module and the planning module.

FIG. 15 is a flow chart of a method of operation of a computing system in a further embodiment of the present invention.

### DETAILED DESCRIPTION

An embodiment of the present invention estimates a learner knowledge model for representing a subject matter known by a user. The learner knowledge model including a mastery level for the subject matter can be generated or adjusted based on a variety of factors.

The learner knowledge model can be based on information gathered during a learning session for teaching or practicing the subject matter through a management platform, including a learner response and a response valuation factor. The learner knowledge model can also be based on a learner profile for the user, the user's activities external to the management platform, or a combination thereof. The learner knowledge model can further be based on data from a learning community sharing various similarities with the user.

A practice recommendation can be made based on the learner knowledge model for practicing and mastering the subject matter specific to the user's characteristics. Learning activities can further be incorporated into user's daily routine outside of the management platform based on the learner knowledge model.

An embodiment of the present invention includes the response evaluation factor including factors in addition to an answer rate provides increased accuracy in understanding the user's knowledge base and proficiency. Further the learner knowledge model based the learner response, the response evaluation factor, and the learner profile provides increased accuracy in understanding the user's knowledge base and proficiency. Moreover, the learner profile and the learner knowledge model based on the learning community provide individual analysis as well as comparison across various groups sharing similarities.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. The software can also include a function, a call to a function, a code block, or a combination thereof. Also for example, the hardware can be circuitry, processor, computer, integrated circuit, integrated circuit cores, a pressure sensor, an inertial sensor, a microelectromechanical system (MEMS), passive devices, physical non-transitory memory medium having instructions for performing the software function, or a combination thereof.

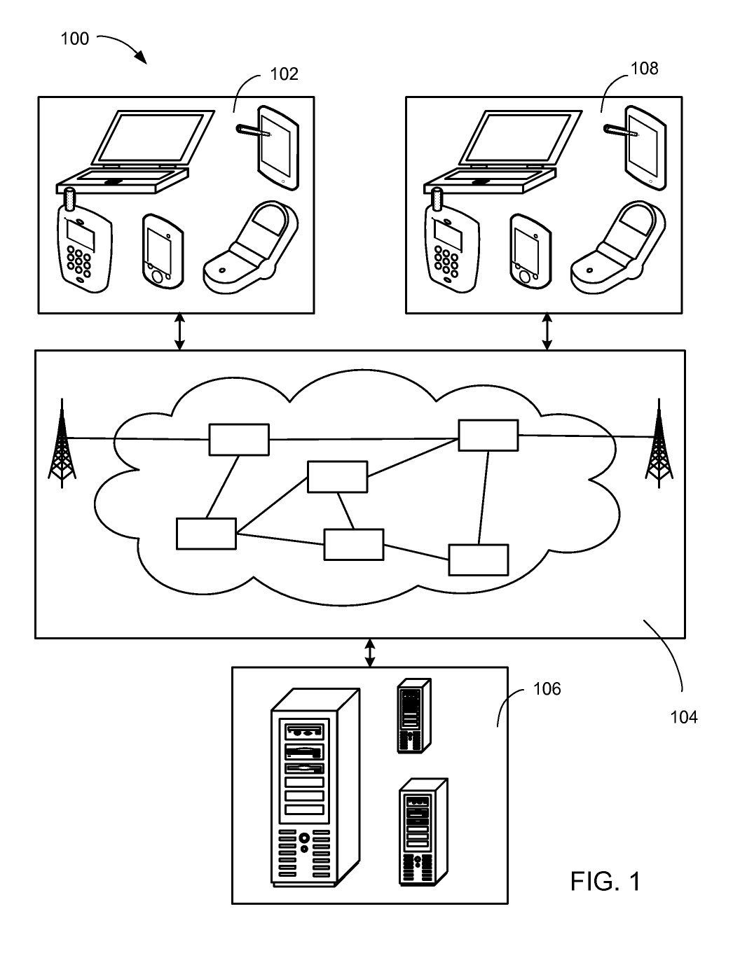

Referring now to FIG. 1, therein is shown a computing system 100 with learning platform mechanism in an embodiment of the present invention. The computing system 100 includes a first device 102, such as a client or a server, connected to a second device 106, such as a client or server, a third device 108, such as a client or server, or a combination thereof through a communication path 104.

Users of the first device 102, the second device 106, the third device 108, or a combination thereof can communicate with each other or access or create information including text, images, symbols, location information, and audio, as examples. The users can be individuals or enterprise companies. The information can be created directly from a user or operations performed based on these information to create more or different information.

The first device 102 can be of any of a variety of devices, such as a smartphone, a cellular phone, personal digital assistant, a tablet computer, a notebook computer, or other multi-functional display or entertainment device. The first device 102 can couple, either directly or indirectly, to the communication path 104 for exchanging information with the second device 106, the third device 108, other devices, or a combination thereof. The first device 102 can further be a stand-alone device or a portion of a subsystem within the computing system 100.

For illustrative purposes, the computing system 100 is described with the first device 102 as a portable personal device, although it is understood that the first device 102 can be different types of devices. For example, the first device 102 can also be a stationary device or a shared device, such as a workstation or a multi-media presentation. A multi-media presentation can be a presentation including sound, a sequence of streaming images or a video feed, text or a combination thereof.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a recording device, such as a camera or video camera, or a combination thereof. In another example, the second device 106 can be a server at a service provider or a computing device at a transmission facility.

The second device 106 can be centralized in a single room, distributed across different rooms, distributed across different geographical locations, embedded within a telecommunications network. The second device 106 can couple with the communication path 104 to communicate with the first device 102, the third device 108, other devices, or a combination thereof.

For illustrative purposes, the computing system 100 is described with the second device 106 as a computing device, although it is understood that the second device 106 can be different types of devices. Also for illustrative purposes, the computing system 100 is shown with the second device 106, the first device 102, the third device 108 as end points of the communication path 104, although it is understood that the computing system 100 can have a different partition between the first device 102, the second device 106, the third device 108, and the communication path 104. For example, the first device 102, the second device 106, the third device 108 or a combination thereof can also function as part of the communication path 104.

For further illustrative purposes, the computing system 100 is described with the first device 102 as a consumer device or a portable device, and with the second device 106 as a stationary or an enterprise device. However, it is understood that the first device 102 and the second device 106 can be any variety of devices. For example, the first device 102 can be a stationary device or an enterprise system, such as a television or a server. Also for example, the second device 106 can be a consumer device or a portable device, such as a smart phone or a wearable device.

The third device 108 can also be any of a variety of devices, such as a smartphone, a cellular phone, personal digital assistant, a tablet computer, a notebook computer, a shared display, an appliance, a device integral with a vehicle or a structure, or other multi-functional display or entertainment device. The third device 108 can couple, either directly or indirectly, to the communication path 104 for exchanging information with the second device 106, the first device 102, other devices, or a combination thereof. The third device 108 can further be a stand-alone device or a portion of a subsystem within the computing system 100.

The first device 102 and the third device 108 can belong to a common user or a set of different users. For example, the first device 102 and the third device 108 can be a smart phone, a tablet, a workstation, a projector, an appliance, or a combination thereof belonging to a single user or a single household. Also for example, the first device 102 can be a personal portable device owned by one user and the third device 108 can be any variety of device owned by another user or shared by a set of users.

The third device 108 can also be a stationary device or a shared device, such as a workstation or a multi-media presentation. The third device 108 can further be a personal device, a portable device, or a combination thereof.

The communication path 104 can span and represent a variety of network types and network topologies. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

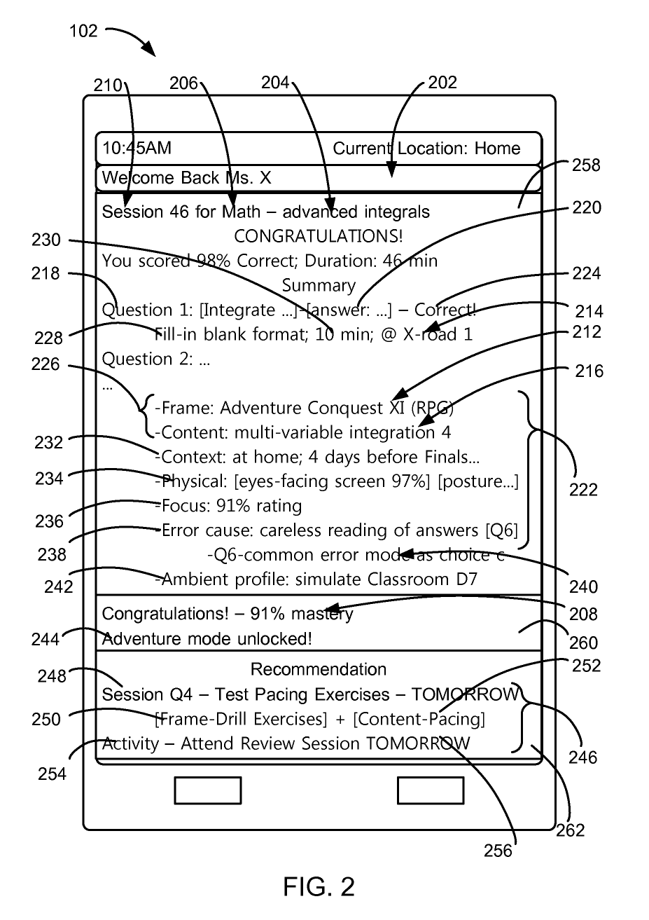

Referring now to FIG. 2, therein is shown an example display of the first device 102. The display can show a management platform 202 for teaching or learning a subject matter 204. The subject matter 204 is particular information targeted or intended for learning. The subject matter 204 can be a fact, a skill, a method, a concept, an abstract construct, or a combination thereof intended to be remembered, used, duplicated, applied, or a combination thereof by a user (not shown).

The subject matter 204 can be represented by the computing system 100 of FIG. 1 by an identifier, such as “civil war” or “advance integral”. The subject matter 204 can have various level of details for describing the particular information. For example, the subject matter 204 can belong to a subject category 206, which can be a well-known categorization for distinguishing various educational disciplines, such as history or math. Also for example, the subject matter 204 can include multiple sub-categorizations, such as “math”, “multiplication”, “integral”, “imaginary number”, or a combination thereof.

The computing system 100 can further include a mastery level 208 corresponding to the subject matter 204. The mastery level 208 is a representation of skillfulness or a confidence level attributed to the user regarding the subject matter 204. The mastery level 208 can be associated with the ability of the user to recall or recognize, use, duplicate, apply, or a combination thereof for the subject matter 204. The mastery level 208 can be quantitatively represented by the computing system 100, such as using a score or a rating.

The computing system 100 can further calculate or determine the mastery level 208 of the user for the subject matter 204 using various information, and use the mastery level 208 to further facilitate the user. Details regarding the mastery level 208 will be discussed below.

The management platform 202 is a set of interaction or communication instruments designed to communicate information for teaching the user. The management platform 202 can communicate information associated with teaching the user, knowledge of the user, or a combination thereof.

The management platform 202 can communicate by displaying, recreating sounds, exchanging information between devices, or a combination thereof. The management platform 202 can communicate the information to the user, other parties or entities associated with teaching the user, such as a trainer or a manager, other device associated therewith, or a combination thereof.

The management platform 202 can be the set of interaction or communication instruments for implementing a learning session 210, managing various resources associated with the learning session 210, schedule the learning session 210, communicating assessment information for the user, providing appropriate incentives, or a combination thereof.

For example, the management platform 202 can include a virtual environment for facilitating the learning session 210. The management platform 202 can display information, audibly recreate sounds, receive interactions from the user, or a combination thereof. The management platform 202 can facilitate teaching and learning of the subject matter 204 for the user to improve the mastery level 208.

As a more specific example, the management platform 202 can include an infrastructure for displaying text information, recreating audio or video for demonstrations, facilitating a gaming application, or a combination thereof. Also for example, the management platform 202 can be the infrastructure for receiving information from the user, observing the user, analyzing the user's performance or knowledge, analyzing information relevant to the user for the purposes of learning, or a combination thereof.

Also for example, the management platform 202 can further include a virtual resource manager for identifying, searching, describing, providing, rating, or a combination thereof for various available resources associated with the learning session 210. As a further example, the management platform 202 can also include an instrument for scheduling the learning session 210 for the user.

The learning session 210 is an activity intended to improve the mastery level 208 of the subject matter 204. For example, the learning session 210 can be a lesson, a test, a game, a practice, a project, or a combination thereof for teaching the subject matter 204 to the user.

The learning session 210 can be a unit of activity, having a beginning and an end. The learning session 210 can be a continuous unit or a collection of separable units or a paused-and-resumed portions within a unit. The learning session 210 can include a lesson frame 212, a lesson content 216, or a combination thereof.

The lesson frame 212 is an instrument for presenting the subject matter 204 for teaching the user. The lesson frame 212 can include a method of presentation, an accompanying background or accessory, or a combination thereof overarching the learning session 210.

For example, the lesson frame 212 can include a framework for a game, an overall story or a story progression, an exercise, or a combination thereof for presenting or facilitating the learning session 210. As a more specific example, the lesson frame 212 can include the rules, the characters, the scenarios, the consequences, the objectives, or a combination thereof and an implementation system for a game for teaching the subject matter 204

The lesson frame 212 can include a content hook 214. The content hook 214 is an instrument for joining the lesson frame 212 and the lesson content 216. For example, the content hook 214 can include a place holder, a reserved space, a link, or a combination thereof in the lesson frame 212 that can connect to the lesson content 216 or a portion therein, such as a key fact or a question.

The lesson content 216 is a presentation of the subject matter 204 for learning. For example, the lesson content 216 can include information for teaching the subject matter 204, a video clip associated with the subject matter 204, a project or a set of questions for capturing the user's input regarding the subject matter 204, or a combination thereof. Also for example, the lesson content 216 can include an assessment component 218.

The assessment component 218 is an instrument for interacting or communicating with the user for gathering information regarding the user's knowledge of the subject matter 204. For example, the assessment component 218 can include a prompt or a question, such as a multiple choice, fill-in-the-blank question, or a combination thereof. Also for example, the assessment component 218 can include a sub-objective, a goal, a milestone, or a combination thereof included in a project. For further example, the assessment component 218 can include a gaming component or an interactive behavior within an interactive game or a challenge used for assessing the mastery level 208.

The computing system 100 can receive a learner response 220. The learner response 220 is input from the user in response to the assessment component 218. The learner response 220 can include information from the user associated with the subject matter 204 and content-based information. For example, the learner response 220 can include an answer to the question, information meeting or responding to the sub-objective, the goal, the milestone, or a combination thereof for the project. Also for example, the learner response 220 can exclude the functional or operational inputs, such as pausing, opening, closing, changing the quality of the input or output, or a combination thereof.

The computing system 100 can further determine a response evaluation factor 222. The response evaluation factor 222 is data associated with the learner response 220 related to the mastery level 208 of the subject matter 204 for the user. The response evaluation factor 222 can include a response accuracy 224 for evaluating the correctness or precision of the learner response 220 in light of the assessment component 218. For example, the response accuracy 224 can be a determination of whether the answer is correct, a Boolean value indicating an incorrect answer, a percentage or a rating for accurate usage or application within the project, or a combination thereof.

The response evaluation factor 222 can include data additional to the accuracy of the learner response 220. For example, the response evaluation factor 222 can include a component description 226, an assessment format 228, an answer rate 230, a contextual parameter 232, a physical indication 234, a learner focus level 236, an error cause estimate 238, or a combination thereof.

The component description 226 is information associated with identification of a component or a provider thereof within the learning session 210. The component description 226 can include identification of the lesson frame 212, the lesson content 216, a provider thereof, the assessment component 218, the subject matter 204, or a combination thereof. For example, the component description 226 can include a name, a number, a link, a contact information, or a combination thereof for the lesson frame 212, the lesson content 216, a provider thereof, the assessment component 218, the subject matter 204, or a combination thereof.

The component description 226 can further include descriptive information for the lesson frame 212, the lesson content 216, a provider thereof, the assessment component 218, the subject matter 204, or a combination thereof. For example, the component description 226 can include a categorization or a classification, a provider summary or description, a reviewer summary, a user summary or comment, or a combination thereof.

The assessment format 228 is a method of addressing the assessment component 218. The assessment format 228 can be a categorization for presenting the assessment component 218, a format restricting or governing the learner response 220, or a combination thereof.

For example, the assessment format 228 can include multiple choice format, fill-in-the-blank format, essays, replication, physical modeling or performance, verbal repetition, or a combination thereof. Also for example, the assessment format 228 can include a user-intake for the user encountering the subject matter 204, such as by reading or listening, or include a user-production for the user generating the learner response 220, other information or usage associated with the subject matter 204, or a combination thereof.

The answer rate 230 is a description of temporal relationship between presenting of the assessment component 218 and the learner response 220. The answer rate 230 can be based on a delay time or a duration measured from outputting the assessment component 218 and receiving user input corresponding to the assessment component 218.

The answer rate 230 can also be based on a frequency of usage or generation of the learner response 220 by the user. For example, the answer rate 230 can include a frequency of an undesirable behavior, such as use of fillers in speech or spelling errors, or a number of attempts associated with the learner response 220.

The contextual parameter 232 is information associated with an abstract importance or meaning relevant to the user and associated with the learning session 210, a component therein, such as the assessment component 218 or the learner response 220, or a combination thereof. The contextual parameter 232 can be associated with a context surrounding the user, the learning session 210, or a combination thereof. For example, the context can include partaking in the learning session 210 at home or a standardized testing center, partaking during lunch or before bed, a significance of the test to the user, such as a licensing or qualifying exam in comparison to an annual work compliance training, or a combination thereof.

Continuing with the example, the contextual parameter 232 can include a user location, a location of user's home or work, a location of a school or a testing center, a current date, a test date, a time of day, a day of the week, identity of people or devices within a preset distance of the user or the user's device, or a combination thereof. The contextual parameter 232 can further include a detail regarding a communication preceding or relating to the learning session 210, such as a communicating party, content, stated subject, user categorization, or a combination thereof.

As a more specific example, the contextual parameter 232 can include a keyword in an email or a scheduled meeting before or after the learning session 210. Also as a more specific example, the contextual parameter 232 can include a confirmation or a registration number stored, received, entered, or a combination thereof by the first device 102, the second device 106 of FIG. 1, the third device 108 of FIG. 1, or a combination thereof.

The physical indication 234 is a representation of a physical aspect of the user during the learning session 210. The physical indication 234 can include a shape, a pattern, a direction, a rate, a movement, or a combination thereof for one or more portions of the user's physical body. For example, the physical indication 234 can include eye movement, blinking rate, body posture, facial expression, head or body orientation or movement, or a combination thereof.

The computing system 100 can visually observe the user and detect the physical indication 234. The computing system 100 can further recognize the physical aspect as a known behavior. For example, the computing system 100 can determine the physical indication 234 as blinking, yawning, looking away, nodding, sleeping, or a combination thereof. Details regarding the physical indication 234 will be discussed below.

The learner focus level 236 is a representation of attention given by the user to the learning session 210. The learner focus level 236 can be indicated by a relative quantity or a rating, such as low-middle-high or a percentage. The learner focus level 236 can be based on the physical indication 234, the subject matter 204, the answer rate 230, the contextual parameter 232, a threshold, or a combination thereof. Details regarding the learner focus level 236 will be discussed below.

The error cause estimate 238 is a determination or a prediction of a source or a contributing factor for an incorrect instance of the learner response 220 in view of the assessment component 218. The error cause estimate 238 can coincide with the response accuracy 224 is below a threshold predetermined by the computing system 100, the lesson content 216, the lesson frame 212, or a combination thereof. The error cause estimate 238 can be based on the learner focus level 236, the contextual parameter 232, other factors, or a combination thereof.

For example, the error cause estimate 238 can be based on a change in the user's schedule or environment or a significant event experienced by the user as indicated by the contextual parameter 232, a distraction during the learning session 210 as indicated by the learner focus level 236 or the contextual parameter 232, or a combination thereof. Also for example, the identity, learning history, a learning attribute, or a combination thereof for the user or the user's community can be a basis for the error cause estimate 238. For further example, the error cause estimate 238 can be based on a source provided by the learning session 210 by design.

The computing system 100 can determine the error cause estimate 238. Details regarding the determination and the use of the error cause estimate 238 will be discussed below.

The learning session 210 can further include a common error 240. The common error 240 is a representation of inaccuracy commonly associated with the assessment component 218. The common error 240 can include a repeated pattern of error for the user, the community of the user, a commonly known to educators or resource providers, or a combination thereof.

For example, the common error 240 can include the user's repeated incorrect instances of the learner response 220 for the assessment component 218, such as involving a specific color or a lower average a specific instance of the assessment format 228 than others. Also for example, the common error 240 can include mistakes, such as in spelling or in forgetting to carry a digit, frequently seen in kids having similar demographics based on a threshold or in comparison to other errors. For further example, the common error 240 can include frequent wrong answers known to teachers, providers of the lesson content 216, providers of the lesson frame 212, tutors, or a combination thereof.

The computing system 100 can identify the common error 240 be based on a threshold, a pattern, a predetermined definition or process, or a combination thereof. The computing system 100 can further utilize the common error 240 in assessing the mastery level 208. Details regarding the common error 240 will be discussed below.

The learning session 210 can further include an ambient simulation profile 242. The ambient simulation profile 242 is a representation of an environment associated with the subject matter 204. The ambient simulation profile 242 can include a sound, a temperature level, a brightness level, a color, an image, or a combination thereof associated with the subject matter 204. For example, the ambient simulation profile 242 can be information for recreating an environment described in the subject matter 204 or a testing center associated with the subject matter 204.

As a more specific example, the ambient simulation profile 242 can be used to control one or more devices in the computing system 100 to recreate a location or an environment, such as the amazon or a city, being taught to the user. Also as a more specific example, the ambient simulation profile 242 can be used to recreate ambient noise, lighting condition, or a combination thereof associated with a test, such as a school exam or a standardized test, associated with the subject matter 204, the user's schedule or goal, or a combination thereof.

The display can further show information generated, calculated, determined, or a combination thereof based on the user's interaction for the subject matter 204. For example, the display can show a mastery reward 244, a practice recommendation 246, or a combination thereof through the management platform 202.

The mastery reward 244 is a prize presented to the user based on the mastery level 208. For example, the mastery reward 244 can include a coupon, a digital or non-digital item, an access to an application or a feature, an increase in quota or a usable commodity, an announcement, a title, a certification, a record, or a combination thereof.

The mastery reward 244 can be based on reaching or surpassing a threshold for the mastery level 208, an overall assessment of the learning session 210, or a combination thereof. The mastery reward 244 can further be based on comparing the mastery level 208, the overall assessment of the learning session 210, or a combination thereof to a community associated with the user. The computing system 100 can provide access to the mastery reward 244 for the user based on the mastery level 208, the overall assessment of the learning session 210, or a combination thereof associated with the subject matter 204.

The practice recommendation 246 is a communication of determined information for facilitating improvement or growth in the mastery level 208. The practice recommendation 246 can include information describing what the user can do, such as an activity or a further instance of the learning session 210, to increase the mastery level 208.

The practice recommendation 246 can include a session recommendation 248, which can further include a frame recommendation 250, a content recommendation 252, or a combination thereof for communicating information for facilitating improvement or growth in the mastery level 208. The session recommendation 248 is a communication of a further instance of the learning session 210. The session recommendation 248 can recommend a subsequent instance of the subject matter 204, the learning session 210, or a combination thereof.

The frame recommendation 250 is a communication of an instance of the lesson frame 212 for the further instance of the learning session 210. The frame recommendation 250 can communicate the instance of the lesson frame 212 determined by the computing system 100 for improving the mastery level 208 specifically for the user.

The content recommendation 252 is a communication of an instance of the lesson content 216 for the further instance of the learning session 210. The content recommendation 252 can communicate the instance of the lesson content 216 determined by the computing system 100 for improving the mastery level 208 specifically for the user.

The practice recommendation 246 can include information describing when, how, or a combination thereof the user can partake in the activity to improve the mastery level 208. The practice recommendation 246 can include an activity recommendation 254, a schedule recommendation 256, or a combination thereof for describing the when and the how for the activity.

The activity recommendation 254 is a communication of an action or an event occurring exclusive of the learning session 210 or the management platform 202. For example, the activity recommendation 254 can include a use or encounter of a particular information, concept, repetition, or a combination thereof associated with the subject matter 204 outside of the learning session 210, the management platform 202, or both. As a more specific example, the activity recommendation 254 can include a usage of a word, application of a mathematical principle, replication of a physical movement, or a combination thereof by the user during the user's daily routine.

The schedule recommendation 256 is a communication of a time associated with the further or subsequent instance of the learning session 210. The schedule recommendation 256 can include a date, a time, or a combination thereof for the next-occurring learning session 210. The schedule recommendation 256 can further include a deadline for completing a task, such as a portion of a project or an assignment, practicing the subject matter 204, a duration where the certification will remain valid, or a combination thereof.

The practice recommendation 246 can be communicated by being displayed or audibly generated by a device in the computing system 100. The practice recommendation 246 can be based on a variety of factors or elements. Details regarding the practice recommendation 246 will be discussed below.

The management platform 202 can include various portions for communicating information associated with teaching the subject matter 204. For example, the management platform 202 can include a lesson portion 258, a reward portion 260, a recommendation portion 262, or a combination thereof.

The lesson portion 258 is a set of interaction or communication instruments for facilitating the learning session 210. The lesson portion 258 can include a graphic user interface (GUI) or a portion therein, a sound, a display of particular information, a displayed screen or a portion therein, a combination thereof, or a specific sequence thereof for facilitating the lesson frame 212, the lesson content 216, the learner response 220, the ambient simulation profile 242, the response evaluation factor 222, or a combination thereof.

For example, the lesson portion 258 can include a sequence of screens or portions of screens conveying the subject matter 204 according to the lesson frame 212. Also for example, the lesson portion 258 can include a viewer for displaying a video for demonstrating the subject matter 204 based on the lesson content 216. For further example, the lesson portion 258 can include a GUI, a sequence of sounds, or a combination thereof for presenting the assessment component 218, receiving the learner response 220, detecting information related to the response evaluation factor 222, recreating conditions according to the ambient simulation profile 242, or a combination thereof.

The reward portion 260 is a set of interaction or communication instruments for awarding the user in association with the learning activity through the mastery reward 244. The reward portion 260 can include the GUI or a portion therein, a sound, a display of particular information, a displayed screen or a portion therein, a function for granting access to a feature or a function within the computing system 100, a combination thereof, or a specific sequence thereof for presenting or availing the mastery reward 244.

For example, the reward portion 260 can display a coupon or a download link for a prize associated with learning activity. Also for example, the reward portion 260 can unlock or grant access to a game or a mode in response to the learning activity.

The recommendation portion 262 is a set of interaction or communication instruments for notifying the user in association with the learning activity through the practice recommendation 246. For example, the recommendation portion 262 can include the GUI or a portion therein, a sound, a display of particular information, a displayed screen or a portion therein, a combination thereof, or a specific sequence thereof for communicating the practice recommendation 246.

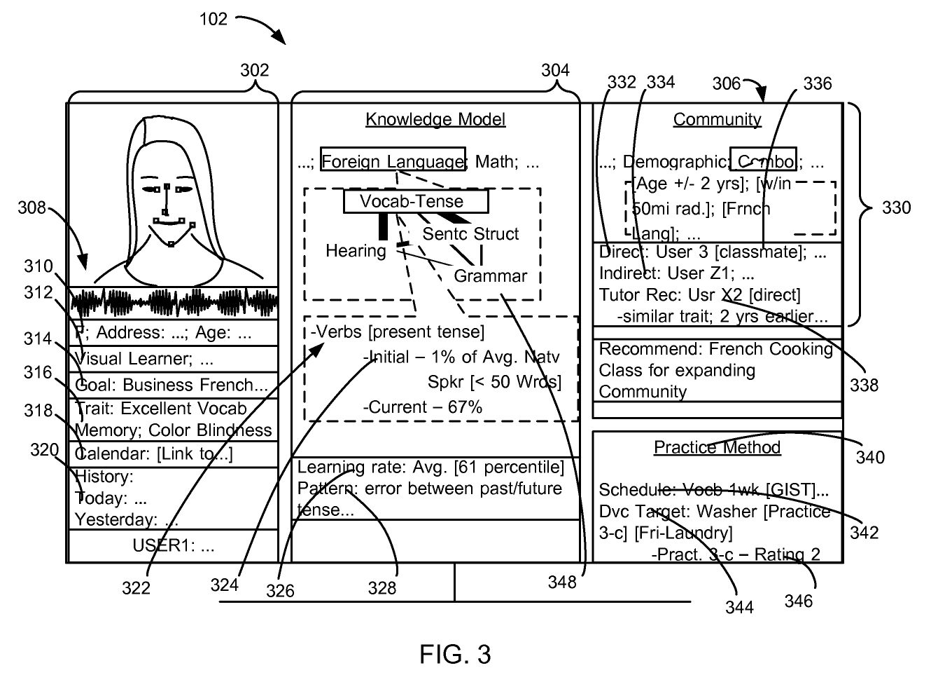

Referring now to FIG. 3, therein is shown a further example display of the first device 102. The display can show the management platform 202 of FIG. 2 including a profile portion 302, a knowledge model portion 304, a community portion 306, or a combination thereof.

The profile portion 302 is a set of interaction or communication instruments for communicating information identifying the user. The profile portion 302 can include a display portion for displaying user's information, an interfacing portion for receiving user's personal or identification information, the GUI implementation thereof, or a combination thereof.

The profile portion 302 can communicate a learner profile 308. The learner profile 308 is a set of information identifying the user, a trait or characteristic of the user, or a combination thereof. For example, the profile portion 302 can include an identification information 310, a learning style 312, a learning goal 314, a learner trait 316, a learner schedule calendar 318, a learner history 320, or a combination thereof.

The identification information 310 can be personal and demographic information for recognizing the user. The identification information 310 can include user's name, age, gender, profession, title, current location, association, such as an enrolled school or group membership, or a combination thereof.

The learning style 312 is a description of a mode or method effective for or preferred by the user. The learning style 312 can be based on the user's natural or habitual pattern of acquiring and processing information. The learning style 312 can further be based on a learning model, such as David Kolb's model or a neuro-linguistic programming model. The learning style 312 can be represented by a categorization or a title, such as a visual learner or a converger, or an arbitrary value associated thereto.

The learning goal 314 is an objective or a purpose associated with learning desired for the user. The learning goal 314 can include a personal target, a lesson plan, a test schedule, a level for the mastery level 208 of FIG. 2, or a combination thereof. The learning goal 314 can be provided by the computing system 100, the user, an educator or a tutor associated with the user, a guardian of the user, a government body, or a combination thereof. The learning goal 314 can be inferred by information attributed to or associated with the user, such as emails, confirmation, the identification information 310, schedule, or a combination thereof.

The learner trait 316 is a pattern or trait attributable to the user. The learner trait 316 can include the user's strengths, weaknesses, affinity, dislikes, or a combination thereof. The learner trait 316 can include a learning disability or exceptional ability or characteristics. The learner trait 316 can be represented by a categorization, a title, an abstract representation thereof, or a combination thereof.

The computing system 100 can determine or estimate the learner trait 316 based on user's interaction with the computing system 100 or the management platform 202. Details regarding the learner trait 316 will be discussed below.

The learner schedule calendar 318 is a collection of information associated with the user and corresponding to dates and times. The learner schedule calendar 318 can include an activity, an event, a meeting, a note, an appointment, a reminder, a trigger, or a combination thereof corresponding to a specific date, a specific time, or a combination thereof. The learner schedule calendar 318 can include the learning session 210 of FIG. 2, information exclusive of the learning session 210 or the management platform 202, or a combination thereof.

The learner history 320 is a record of user's experience related to increasing the mastery level 208. The learner history 320 can include previously or currently occurring activity, event, meeting, appointment, trigger, the learning session 210, a record of interactions with the management platform 202, or a combination thereof. The learner history 320 can include information associated with the user's previous experience, such as the lesson frame 212 of FIG. 2, the learner response 220 of FIG. 2, the response evaluation factor 222 of FIG. 2, the common error 240 of FIG. 2, the mastery reward 244, the practice recommendation 246 of FIG. 2, or a combination thereof.

The learner history 320 can further include user's experience exclusive of the learning session 210 or the management platform 202. For example, the learner history 320 can include a class taken or enrolled for the user, an achievement accomplished by the user, a certification or a degree awarded to the user, a score or an assessment associated therewith, a combination thereof.

The knowledge model portion 304 is a set of interaction or communication instruments for communicating a representation of information retained or accessible by the user and a proficiency attributed to the retention or the accessibility. The knowledge model portion 304 can include a display portion for displaying a model of information known to the user, skills accessible by the user, the proficiency associated therewith, or a combination thereof.

The knowledge model portion 304 can communicate a learner knowledge model 322. The learner knowledge model 322 is a representation of information or skill accessible by the user and the proficiency associated therewith. The learner knowledge model 322 can be represented using text, numbers, graphs, categories, a map, or a combination thereof.

The learner knowledge model 322 can represent one or more instances of the subject matter 204 of FIG. 2 and the mastery level 208 associated therewith for the user. The learner knowledge model 322 can further represent one, multiple, a specific set, or all identified instances of the subject category 206 for the user.

For example, the learner knowledge model 322 can represent the user's proficiency for an academic subject or a subcomponent therein, such as World History or addition. Also for example, the learner knowledge model 322 can represent the user's skill level regarding all possible skills applicable to a specific department or group within a company.

The learner knowledge model 322 can represent knowledge of the user at a current time. The learner knowledge model 322 can further represent knowledge of the user over a period of time, such as with previous instances of the learner knowledge model 322, changes over the period of time, or a combination thereof.

The learner knowledge model 322 can include various information regarding the user's skill or knowledge, or changes thereto. For example, the learner knowledge model 322 can include a starting point 324, a learning rate 326, a learner-specific pattern 328, or a combination thereof.

The starting point 324 can be an abstract representation of information or skill already existing or attainable with the user prior to the teaching activity, first instance of the learning session 210, or a combination thereof for a specific instance of the subject matter 204. The starting point 324 can be based on user's interaction with an external source or from an encounter with a related instance of the subject matter 204.

The computing system 100 can determine the starting point 324 based on information from the user directly related to the starting point 324 or the specific instance of the subject matter 204, such as an input of user's attained degrees or through an assessment test or survey. The computing system 100 can also determine the starting point 324 by inferring the starting point 324 without using information directly related to the starting point 324 or the specific instance of the subject matter 204. Details regarding the starting point 324 will be discussed below.

The learning rate 326 is a speed, a duration, or a quantity associated with changes in the learner knowledge model 322. The learning rate 326 can be the speed or the duration associated with changes in the mastery level 208 for the specific instance of the subject matter 204. The learning rate 326 can be represented by an arbitrary quantity, such as a number or a ratio, a duration, a scale, a normalization or an average factor, or a combination thereof. The learning rate 326 can further be represented by a number of practices or attempts associated with the subject matter 204.

The learner-specific pattern 328 is an arrangement or a configuration of information associated with the user's knowledge or a change therein. The learner-specific pattern 328 can be an arrangement or a configuration of the user's performance or usage associated with the subject matter 204.

The learner-specific pattern 328 can include a pattern in the response evaluation factor 222. The learner-specific pattern 328 can include an error pattern, a pattern of excellence or high performance, or a combination thereof. The learner-specific pattern 328 can include a pattern based on various factors, such as the learning session 210, including the lesson frame 212, the lesson content 216 of FIG. 2, the common error 240, the ambient simulation profile 242 of FIG. 2, the response evaluation factor 222, or a combination thereof.

The learner-specific pattern 328 can further include a pattern of access for the learning activity. For example, the learner-specific pattern 328 can include the user's school schedule, a work schedule, a training regimen. Also for example, the learner-specific pattern 328 a pattern for accessing the management platform 202, the learning session 210, the subject matter 204, the mastery level 208 associated therewith, a change therein, or a combination thereof.

The learner-specific pattern 328 can describe the user's strength, weakness, tendency, preference, or a combination thereof. The learner-specific pattern 328 can be a pattern within one instance or a pattern across or with multiple instances of the subject matter 204.

The community portion 306 is a set of interaction or communication instruments for communicating information regarding people or entities related to the learning activity. The community portion 306 can include a display portion, a GUI, an audible output, or a combination thereof for displaying people having similar aspect or characteristic as the user, people or entities associated with the learning session 210 or other learning activities for the user, such as a teacher or a parent, people or tutors previously or recently mastering the subject matter 204, or a combination thereof.

The community portion 306 can communicate a learning community 330. The learning community 330 is a grouping of people, entities, organizations, or a combination thereof associated with the user based on the learning activity. The learning community 330 can include a connection, such as through a previous meeting or a common friend or membership, between the user and the grouping of people, entities, organizations, or a combination thereof. The learning community 330 can include contact information or method for the people, entities, organizations, or a combination thereof.

The learning community 330 can include various different types of people, entities, organizations, or a combination thereof. For example, the learning community 330 can include people, entities, organizations, or a combination thereof through a direct connection 332 or an indirect link 334 to the user, including a learning peer 336, a subject tutor 338, other people, entities, organizations, or a combination thereof.

The direct connection 332 is an association based on purposeful and intentional interaction between the user and the people, entities, organizations, or a combination thereof. The direct connection 332 can include people, entities, organizations, or a combination thereof having had personal encounters, direct communication, such as through speaking or digital correspondence, or a combination thereof with the user.

The indirect link 334 is an association based on similarities and exclusive of purposeful and intentional interaction between the user and the people, entities, organizations, or a combination thereof. The indirect link 334 can include people, entities, organizations, or a combination thereof sharing a similar characteristic or trait with the user but lacking any form of relationship or connection with the user.

For example, the user's teacher or classmates can be connected to the user through the direct connection 332 due to their interactions in person. Also for example, other students having similar demographic information, such as same grade or located in the same area, or tutoring service having experiences with children having similar instance of the learner profile 308 can be connected to the user through the indirect link 334. As a more specific example, the tutoring service can change from the indirect link 334 to the direct connection 332 when the user enrolls for the tutoring service.

The learning peer 336 is a person or a grouping of people having similarities to the user. The learning peer 336 can include the direct connection 332, the indirect link 334, or a combination thereof. For example, the learning peer 336 can include the direct connection 332 for people connected to the user through a common learning activity, such as a classmate, a teammate, a social friend, or a combination thereof.

Also for example, the learning peer 336 can also include the indirect link 334 for people having same or similar demographic information as the user, as indicated in the identification information 310, such as same age, grade, position or title, gender, location, ethnic background, education level, or a combination thereof. For further example, the learning peer 336 can further include people having similar knowledge or traits and characteristics associated thereto, as indicated by similarities in the learner profile 308, the mastery level 208, the subject matter 204, the learner knowledge model 322, or a combination thereof.

The subject tutor 338 is a person or an entity having the person capable of helping the user learn the subject matter 204. The subject tutor 338 can include the direct connection 332, the indirect link 334, or a combination thereof.

The subject tutor 338 can have a distinct characteristic or a specific trait in their instance of the learner profile 308, the learner knowledge model 322, or a combination thereof. For example, the subject tutor 338 can have a higher instance of the mastery level 208 than the user for the subject matter 204. Also for example, the subject tutor 338 can have the mastery level 208 satisfying a requirement determined by the computing system 100 for teaching or conveying information, having similar experiences or background as the user, training in recognizing and working with an aspect of the user, such as indicated in the learner profile 308, or a combination thereof.

The subject tutor 338 can include a teacher, a recognized tutor, a tutoring service or program, a trainer, a training service or program, a person having higher instance of the mastery level 208 or having previously experienced the subject matter 204, or a combination thereof. The subject tutor 338 can start as the indirect link 334 when the computing system 100 communicates or identifies the subject tutor 338 through an aide portion. The subject tutor 338 can become the direct connection 332 after the user interacts with the subject tutor 338. The subject tutor 338 can further start as the direct connection 332 for family members and friends capable of aiding the user's learning activity.

The learning community 330 can further include teachers, guardians, employers, managers, schools, companies, overseeing or involved in the learning activity for the user, associated with the learning session or the management platform 202, or external to the learning session and the management platform 202. The learning community 330 can similarly include providers, such as for the lesson frame 212 or the mastery reward 244, providing information associated with the learning activity, the management platform 202, the learning session 210, or a combination thereof.

The computing system 100 can further include and display a practice method 340, a subject connection model 348, or a combination thereof. The practice method 340 is a technique or a process for reinforcing the subject matter 204 for the user.

The practice method 340 can include a set of steps, activities, an assessment instrument, a timing, a variation therein, or a combination thereof for enhancing the mastery level 208 for the subject matter 204. The practice method 340 can include educational methods, psychological models, or a combination thereof, such as graduated interval method, immersion training, impulse training, or a combination thereof. The practice method 340 can include a lesson plan, a training regimen, or a combination thereof.

The computing system 100 can represent the practice method 340 as a process or a sequence of steps including one or more instances of the learning session 210, a timing thereof, an assessment thereof, or a combination thereof. The practice method 340 can include instrument for determining the timing and a nature or a type of subsequent activity based on the learner knowledge model 322, the mastery level 208, the response evaluation factor 222, or a combination thereof.

The practice method 340 can include a practice schedule 342, a device target 344, a difficulty rating 346, or a combination thereof. The practice schedule 342 is the timing for one or more instances of the learning session 210. The practice schedule 342 can be represented as a duration until a next occurring instance, a time and date for the occurrence, or a combination thereof for the learning session 210 or a task to be performed by the user. The practice schedule 342 can be associated with the schedule recommendation 256 of FIG. 2. The practice schedule 342 can be based on educational methods, psychological models, or a combination thereof, such as graduated interval method, immersion training, impulse training, or a combination thereof.

The device target 344 is a designation or identification of a device for implementing the learning activity. For example, the device target 344 can include an internet-protocol address or a device serial number for implementing the learning session 210, receiving inputs from the user in executing the activity recommendation 254 of FIG. 2, or a combination thereof.

The difficulty rating 346 is an evaluation of the mastery level 208 of the user required for successfully completing the learning activity. The difficulty rating 346 can be represented by an arbitrary value, a scale, a threshold, or a combination thereof predetermined by the computing system 100, a provider of the lesson content 216 or the lesson frame 212, or a combination thereof.

The difficulty rating 346 can include an assessment of the practice recommendation 246 including the activity recommendation 254, the learning session 210, including the lesson content 216, the assessment component 218 of FIG. 2, the response evaluation factor 222, such as the assessment format 228 of FIG. 2 or the contextual parameter 232 of FIG. 2, the common error 240, the ambient simulation profile 242 of FIG. 2, or a combination thereof. The difficulty rating 346 can further include an assessment of the user's demonstration of the mastery level 208 including the learner response 220, input data corresponding to the activity recommendation 254, behavior or action of the user corresponding to the subject matter 204, or a combination thereof.

For example, the difficulty rating 346 can be higher for fill-in-the-blank type of question than multiple choice. Also for example, the difficulty rating 346 can be lower when the user encounters the subject matter 204, such as by viewing or hearing, than when the user proactively acts based on the subject matter 204, such as by speaking or performing a task requiring knowledge of the subject matter 204.

The subject connection model 348 is a representation of a link or a relationship between various instances of the subject matter 204. The subject connection model 348 can include a connection between instances of the subject matter 204, an evaluation of the connection, a nature of the connection, or a combination thereof.

For example, the subject connection model 348 can describe one instance of the subject matter 204 being a required basis for another subject matter 204, a similar or related matter, unrelated matter, or a combination thereof. Also for example, the subject connection model 348 can describe a relationship between the mastery level 208 between instances of the subject matter 204, including an inference of the mastery level 208 for one instance of the subject matter 204 based on the mastery level 208 of another instance of the subject matter 204.

As a more specific example, the subject connection model 348 can describe ‘addition’ as being the required basis for ‘multiplication’, a relationship between the mastery level 208 corresponding to ‘addition’ and ‘multiplication’, such as by a percentage or an equation, or a combination thereof. Also as a more specific example, the subject connection model 348 can describe the connection between learning various tenses for verbs in language and hearing comprehension, sentence structure, grammar, or a combination thereof. The subject connection model 348 can show the evaluation of the connection or the inference of the mastery level 208 using a thickness of a line, for one instance of the subject matter 204 based on the mastery level 208 of another instance of the subject matter 204, or a combination thereof.

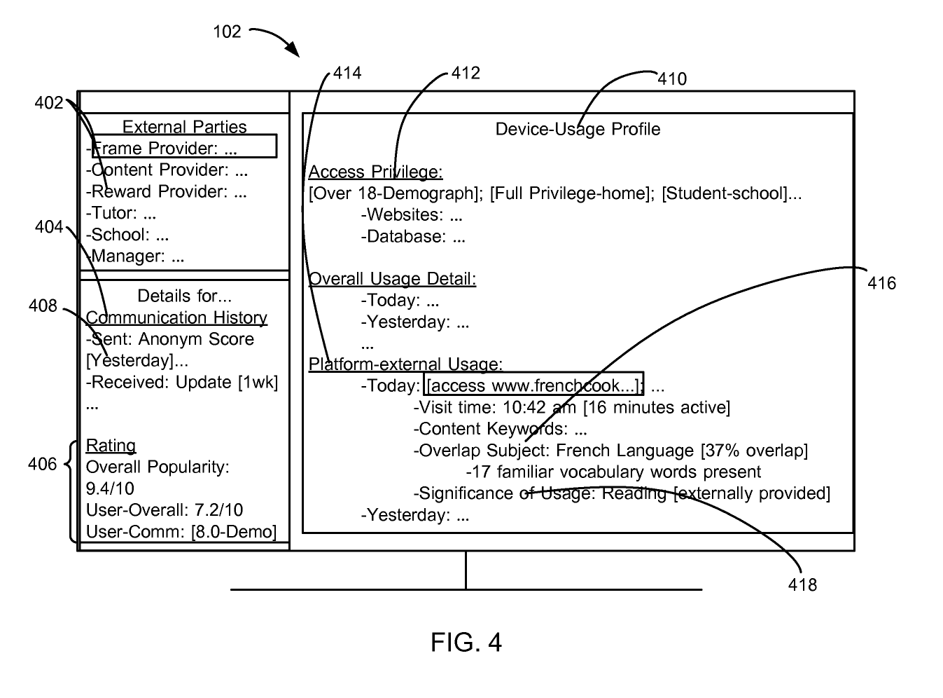

Referring now to FIG. 4, therein is shown a further example display of the first device 102. The display can show a representation of an external entity 402. The external entity 402 can include a provider, such as a designer, a developer, a seller, a distributor, or a combination thereof. The external entity 402 can be the provider for the management platform 202 of FIG. 2, the lesson frame 212 of FIG. 2, the lesson content 216 of FIG. 2, the assessment component 218 of FIG. 2, the mastery reward 244 of FIG. 2, the ambient simulation profile 242 of FIG. 2, or a combination thereof.

The external entity 402 can further include a person or an entity associated with user or user's learning activity. For example, the external entity 402 can include a teacher, a school, a tutor, a tutoring service, a manager or a supervisor, a company or a workplace, or a combination thereof. Also for example, the external entity 402 can include a parent or a guardian.

The computing system 100 can represent the external entity 402 with identification information, contact information, or a combination thereof. For example, the external entity 402 can be represented as a name, a serial number, an identifier, a categorization, a phone number, an email address, a link or an internet address, computer identification information, or a combination thereof. The computing system 100 can further represent the external entity 402 as communication software, an application, a hardware interface, or a combination thereof.

The display can further show information associated with the external entity 402. For example, the display can show an external feedback 404, an external-entity assessment 406, an external-entity input 408, or a combination thereof.

The external feedback 404 is information sent to the external entity 402 from or through the management platform 202. The external feedback 404 can be a variety of information. For example, the external feedback 404 can include information regarding the user or information produced by the computing system 100, such as the learner profile 308 of FIG. 3, the learner knowledge model 322 of FIG. 3, the learner response 220 of FIG. 2 from the user, or a combination thereof.

As a more specific example, the external feedback 404 can include a usage information, scoring information, or a combination thereof associated with the learning session 210 of FIG. 2. Also as a more specific example, the external feedback 404 can include a suggestion, a rating or an evaluation of the external entity 402 or a product thereof, or a combination thereof.

The external-entity assessment 406 is an evaluation of the external entity 402 or a product thereof. For example, the external-entity assessment 406 can include a rating or an assessment of the external entity 402, or a rating or an assessment of the product from the external entity 402, such as the lesson frame 212, the lesson content 216, the assessment component 218, the mastery reward 244, or a combination thereof.

The external-entity assessment 406 can be information provided by the user, the computing system 100, or a combination thereof. The external-entity assessment 406 can further be provided by a different instance of the external entity 402. For example, the external-entity assessment 406 can be provided by a school or a teacher for evaluating a component of the learning session 210, a tutor or a tutoring service, or a combination thereof.

The external feedback 404 can include the external-entity assessment 406 and can be sent to the external entity 402. The external-entity assessment 406 can be provided to the user, the computer system 100, other instances of the external entity 402, or a combination thereof. The external-entity assessment 406 can include an overall score, effectiveness, a rating, compatibility, or a combination thereof given by the user, corresponding to the user, or a combination thereof. The external-entity assessment 406 can further include a score, effectiveness, rating, compatibility, or a combination thereof corresponding to a specific aspect of the user, such as for the learner profile 308 or the learner knowledge model 322, a specific instance of the learner community 330, or a combination thereof corresponding to the user.

The external-entity assessment 406 can further include a benchmark ranking. The benchmark ranking can rank the ratings for multiple instances of the external entity 402 in specific categories. The categories can be based on the subject matter 204, the traits in the learner profile 308, the learner knowledge model 322, the learning community 330, or a combination thereof.

The external-entity input 408 is information from the external entity 402 communicated to or through the management platform 202. For example, the external-entity input 408 can include an access permission, such as for accessing specific websites or features, a control information, such as for a device or the management platform 202, a message, an update, or a combination thereof.

The display can further show a device-usage profile 410. The device-usage profile 410 is a record of user's interaction with one or more device. The device-usage profile 410 can include a time, a frequency, a duration, or a combination thereof for the user's interaction with the computing system 100.

The device-usage profile 410 can further include identification information for application or software used, a content accessed, a physical location at the time of the interaction, other contextual information, or a combination thereof. The device-usage profile 410 can include user's interaction with the first device 102 of FIG. 1, the second device 106 of FIG. 1, the third device 108 of FIG. 1, or a combination thereof. The device-usage profile 410 can further include the user's interaction with the management platform 202, or interactions external or unrelated to the management platform 202.

The device-usage profile 410 can include a history of interactions with the computing system 100 or a device therein for the user. The device-usage profile 410 can further include identification information of one or more devices, or all of the devices, owned by or accessible to the user. The device-usage profile 410 can also include access history or access pattern of the one or more devices by the user.

For example, the device-usage profile 410 can include an access privilege 412, a platform-external usage 414, a contextual overlap 416, a usage significance 418, or a combination thereof. The access privilege 412 is a representation of accessibility of the user regarding the subject matter 204 of FIG. 2. The access privilege 412 can include a website, a feature, a function, or a combination thereof. The access privilege 412 can be associated with the subject matter 204, the management platform 202, the platform-external usage 414, or a combination thereof.

The platform-external usage 414 is an activity or an interaction of the user excluding the management platform 202, the learning session 210, or a combination thereof. The platform-external usage 414 can include the activity or the usage of the user involving the first device 102, the second device 106, the third device 108, or a combination thereof independent of the learning session 210, the management platform 202, or a combination thereof.

The platform-external usage 414 can include the activity or the usage involving software processes, applications, data, or a combination thereof exclusive of the management platform 202, the learning session 210, or a combination thereof. For example, the platform-external usage 414 can include activities or usages of internet browsers, messaging application, games, telephone function, video communication, such as a video chat or a video player, or a combination thereof.

The computing system 100 can represent the platform-external usage 414 by a name or categorization of the activity or the usage, the identification of the application or the software process accessed during the activity or the usage, or a combination thereof. The computing system 100 can further represent the platform-external usage 414 based on contextual information, such as a time, a duration, a frequency, or a combination thereof for the activity or the usage, the location of the user or the device at the time of the activity or the usage, other contextual information associated with the activity or the usage, or a combination thereof. The platform-external usage 414 can further include content information accessed during the activity or the usage.

The contextual overlap 416 is an indication of relevance between the platform-external usage 414 and the subject matter 204. The contextual overlap 416 can represent an alignment or a similarity between one or more instance of the subject matter 204 and the platform-external usage 414.

The computing system 100 can determine the contextual overlap 416 for the platform-external usage 414. The computing system 100 can determine the contextual overlap 416 based on comparing the platform-external usage 414 and the subject matter 204. Details regarding the contextual overlap 416 will be discussed below.

The usage significance 418 is an evaluation of the mastery level 208 of FIG. 2 indicated by the platform-external usage 414 for the subject matter 204. The usage significance 418 can be based on the contextual overlap 416. The usage significance 418 can be for the platform-external usage 414. The usage significance 418 can be associated with one or more instances of the subject matter 204.

The usage significance 418 can be represented as a categorization for the platform-external usage 414. For example, the usage significance 418 can include a passive categorization, such as hearing or reading, or an active categorization, such as writing or speaking. Also for example, the usage significance 418 can be represented as an arbitrary score or rating of the mastery level 208 indicated by the platform-external usage 414.

The computing system 100 can determine the usage significance 418. Details regarding the usage significance 418 will be discussed below.

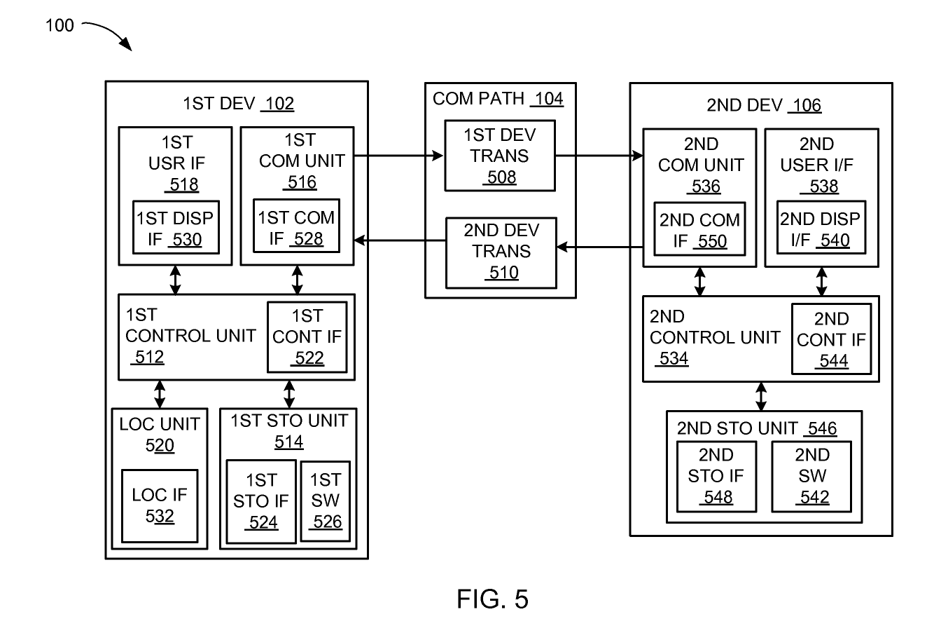

Referring now to FIG. 5, therein is shown an exemplary block diagram of the computing system 100. The computing system 100 can include the first device 102, the communication path 104, and the second device 106. The first device 102 can send information in a first device transmission 508 over the communication path 104 to the second device 106. The second device 106 can send information in a second device transmission 510 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 512, a first storage unit 514, a first communication unit 516, and a first user interface 518, and a location unit 520. The first control unit 512 can include a first control interface 522. The first control unit 512 can execute a first software 526 to provide the intelligence of the computing system 100.

The first control unit 512 can be implemented in a number of different manners. For example, the first control unit 512 can be a processor, an application specific integrated circuit (ASIC) an embedded processor, a microprocessor, a hardware control logic, a hardware finite state machine (FSM), a digital signal processor (DSP), or a combination thereof. The first control interface 522 can be used for communication between the first control unit 512 and other functional units in the first device 102. The first control interface 522 can also be used for communication that is external to the first device 102.

The first control interface 522 can receive information from the other functional units or from external sources, or can transmit information to the other functional units or to external destinations. The external sources and the external destinations refer to sources and destinations external to the first device 102.

The first control interface 522 can be implemented in different ways and can include different implementations depending on which functional units or external units are being interfaced with the first control interface 522. For example, the first control interface 522 can be implemented with a pressure sensor, an inertial sensor, a microelectromechanical system (MEMS), optical circuitry, waveguides, wireless circuitry, wireline circuitry, or a combination thereof.

The first storage unit 514 can store the first software 526. The first storage unit 514 can also store the relevant information, such as data representing incoming images, data representing previously presented image, sound files, or a combination thereof.

The first storage unit 514 can be a volatile memory, a nonvolatile memory, an internal memory, an external memory, or a combination thereof. For example, the first storage unit 514 can be a nonvolatile storage such as non-volatile random access memory (NVRAM), Flash memory, disk storage, or a volatile storage such as static random access memory (SRAM).

The first storage unit 514 can include a first storage interface 524. The first storage interface 524 can be used for communication between the first storage unit 514 and other functional units in the first device 102. The first storage interface 524 can also be used for communication that is external to the first device 102.

The first storage interface 524 can receive information from the other functional units or from external sources, or can transmit information to the other functional units or to external destinations. The external sources and the external destinations refer to sources and destinations external to the first device 102.

The first storage interface 524 can include different implementations depending on which functional units or external units are being interfaced with the first storage unit 514. The first storage interface 524 can be implemented with technologies and techniques similar to the implementation of the first control interface 522.

The first communication unit 516 can enable external communication to and from the first device 102. For example, the first communication unit 516 can permit the first device 102 to communicate with the second device 106, the third device 108 of FIG. 1, an attachment, such as a peripheral device or a desktop computer, the communication path 104, or a combination thereof.

The first communication unit 516 can also function as a communication hub allowing the first device 102 to function as part of the communication path 104 and not limited to be an end point or terminal unit to the communication path 104. The first communication unit 516 can include active and passive components, such as microelectronics or an antenna, for interaction with the communication path 104.

The first communication unit 516 can include a first communication interface 528. The first communication interface 528 can be used for communication between the first communication unit 516 and other functional units in the first device 102. The first communication interface 528 can receive information from the other functional units or can transmit information to the other functional units.

The first communication interface 528 can include different implementations depending on which functional units are being interfaced with the first communication unit 516. The first communication interface 528 can be implemented with technologies and techniques similar to the implementation of the first control interface 522.

The first user interface 518 allows a user (not shown) to interface and interact with the first device 102. The first user interface 518 can include an input device and an output device. Examples of the input device of the first user interface 518 can include a keypad, a touchpad, soft-keys, a keyboard, a microphone, an infrared sensor for receiving remote signals, or any combination thereof to provide data and communication inputs.

The first user interface 518 can include a first display interface 530. The first display interface 530 can include an output device. The first display interface 530 can include a display, a projector, a video screen, a speaker, or any combination thereof.

The first control unit 512 can operate the first user interface 518 to display information generated by the computing system 100. The first control unit 512 can also execute the first software 526 for the other functions of the computing system 100, including receiving location information from the location unit 520. The first control unit 512 can further execute the first software 526 for interaction with the communication path 104 via the first communication unit 516.

The location unit 520 can generate location information, current heading, current acceleration, and current speed of the first device 102, as examples. The location unit 520 can be implemented in many ways. For example, the location unit 520 can function as at least a part of the global positioning system, an inertial computing system, a cellular-tower location system, a pressure location system, or any combination thereof. Also, for example, the location unit 520 can utilize components such as an accelerometer or GPS receiver.

The location unit 520 can include a location interface 532. The location interface 532 can be used for communication between the location unit 520 and other functional units in the first device 102. The location interface 532 can also be used for communication external to the first device 102.

The location interface 532 can receive information from the other functional units or from external sources, or can transmit information to the other functional units or to external destinations. The external sources and the external destinations refer to sources and destinations external to the first device 102.

The location interface 532 can include different implementations depending on which functional units or external units are being interfaced with the location unit 520. The location interface 532 can be implemented with technologies and techniques similar to the implementation of the first control unit 512.

The second device 106 can be optimized for implementing an embodiment of the present invention in a multiple device embodiment with the first device 102. The second device 106 can provide the additional or higher performance processing power compared to the first device 102. The second device 106 can include a second control unit 534, a second communication unit 536, a second user interface 538, and a second storage unit 546.

The second user interface 538 allows a user (not shown) to interface and interact with the second device 106. The second user interface 538 can include an input device and an output device. Examples of the input device of the second user interface 538 can include a keypad, a touchpad, soft-keys, a keyboard, a microphone, or any combination thereof to provide data and communication inputs. Examples of the output device of the second user interface 538 can include a second display interface 540. The second display interface 540 can include a display, a projector, a video screen, a speaker, or any combination thereof.

The second control unit 534 can execute a second software 542 to provide the intelligence of the second device 106 of the computing system 100. The second software 542 can operate in conjunction with the first software 526. The second control unit 534 can provide additional performance compared to the first control unit 512.

The second control unit 534 can operate the second user interface 538 to display information. The second control unit 534 can also execute the second software 542 for the other functions of the computing system 100, including operating the second communication unit 536 to communicate with the first device 102 over the communication path 104.

The second control unit 534 can be implemented in a number of different manners. For example, the second control unit 534 can be a processor, an embedded processor, a microprocessor, hardware control logic, a hardware finite state machine (FSM), a digital signal processor (DSP), or a combination thereof.

The second control unit 534 can include a second control interface 544. The second control interface 544 can be used for communication between the second control unit 534 and other functional units in the second device 106. The second control interface 544 can also be used for communication that is external to the second device 106.

The second control interface 544 can receive information from the other functional units or from external sources, or can transmit information to the other functional units or to external destinations. The external sources and the external destinations refer to sources and destinations external to the second device 106.

The second control interface 544 can be implemented in different ways and can include different implementations depending on which functional units or external units are being interfaced with the second control interface 544. For example, the second control interface 544 can be implemented with a pressure sensor, an inertial sensor, a microelectromechanical system (MEMS), optical circuitry, waveguides, wireless circuitry, wireline circuitry, or a combination thereof.

A second storage unit 546 can store the second software 542. The second storage unit 546 can also store the information such as data representing incoming images, data representing previously presented image, sound files, or a combination thereof. The second storage unit 546 can be sized to provide the additional storage capacity to supplement the first storage unit 514.

For illustrative purposes, the second storage unit 546 is shown as a single element, although it is understood that the second storage unit 546 can be a distribution of storage elements. Also for illustrative purposes, the computing system 100 is shown with the second storage unit 546 as a single hierarchy storage system, although it is understood that the computing system 100 can have the second storage unit 546 in a different configuration. For example, the second storage unit 546 can be formed with different storage technologies forming a memory hierarchal system including different levels of caching, main memory, rotating media, or off-line storage.

The second storage unit 546 can be a volatile memory, a nonvolatile memory, an internal memory, an external memory, or a combination thereof. For example, the second storage unit 546 can be a nonvolatile storage such as non-volatile random access memory (NVRAM), Flash memory, disk storage, or a volatile storage such as static random access memory (SRAM).

The second storage unit 546 can include a second storage interface 548. The second storage interface 548 can be used for communication between the second storage unit 546 and other functional units in the second device 106. The second storage interface 548 can also be used for communication that is external to the second device 106.

The second storage interface 548 can receive information from the other functional units or from external sources, or can transmit information to the other functional units or to external destinations. The external sources and the external destinations refer to sources and destinations external to the second device 106.

The second storage interface 548 can include different implementations depending on which functional units or external units are being interfaced with the second storage unit 546. The second storage interface 548 can be implemented with technologies and techniques similar to the implementation of the second control interface 544.

The second communication unit 536 can enable external communication to and from the second device 106. For example, the second communication unit 536 can permit the second device 106 to communicate with the first device 102 over the communication path 104.

The second communication unit 536 can also function as a communication hub allowing the second device 106 to function as part of the communication path 104 and not limited to be an end point or terminal unit to the communication path 104. The second communication unit 536 can include active and passive components, such as microelectronics or an antenna, for interaction with the communication path 104.

The second communication unit 536 can include a second communication interface 550. The second communication interface 550 can be used for communication between the second communication unit 536 and other functional units in the second device 106. The second communication interface 550 can receive information from the other functional units or can transmit information to the other functional units.

The second communication interface 550 can include different implementations depending on which functional units are being interfaced with the second communication unit 536. The second communication interface 550 can be implemented with technologies and techniques similar to the implementation of the second control interface 544.

The first communication unit 516 can couple with the communication path 104 to send information to the second device 106 in the first device transmission 508. The second device 106 can receive information in the second communication unit 536 from the first device transmission 508 of the communication path 104.

The second communication unit 536 can couple with the communication path 104 to send information to the first device 102 in the second device transmission 510. The first device 102 can receive information in the first communication unit 516 from the second device transmission 510 of the communication path 104. The computing system 100 can be executed by the first control unit 512, the second control unit 534, or a combination thereof. For illustrative purposes, the second device 106 is shown with the partition having the second user interface 538, the second storage unit 546, the second control unit 534, and the second communication unit 536, although it is understood that the second device 106 can have a different partition. For example, the second software 542 can be partitioned differently such that some or all of its function can be in the second control unit 534 and the second communication unit 536. Also, the second device 106 can include other functional units not shown in FIG. 5 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

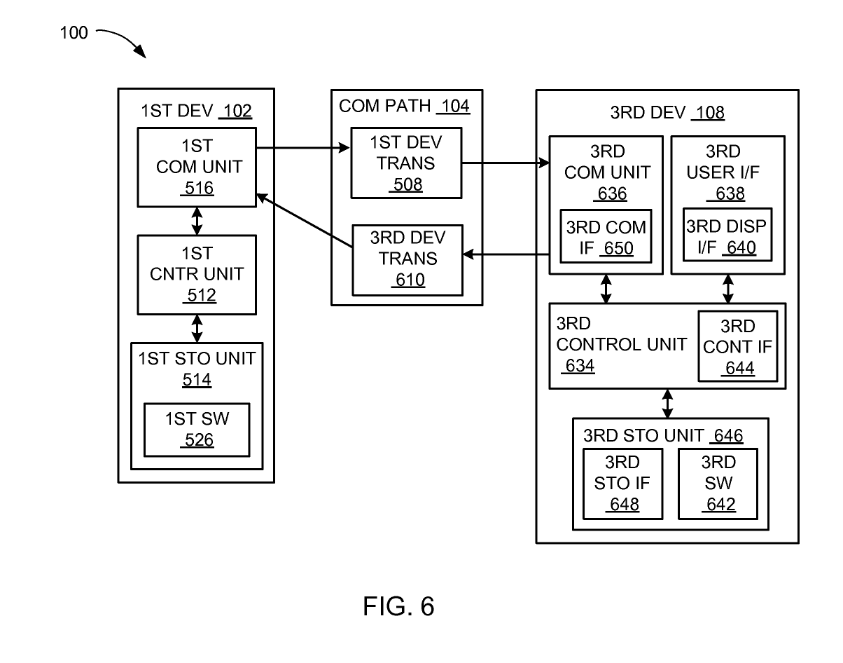

Referring now to FIG. 6, therein is shown a further exemplary block diagram of the computing system 100. Along with the first device 102, and the second device 106 of FIG. 5, the computing system 100 can include the third device 108. The first device 102 can send information in the first device transmission over the communication path 104 to the third device 108. The third device 108 can send information in a third device transmission 610 over the communication path 104 to the first device 102, the second device 106, or a combination thereof.

For illustrative purposes, the computing system 100 is shown with the third device 108 as a client device, although it is understood that the computing system 100 can have the third device 108 as a different type of device. For example, the third device 108 can be a server.

Also for illustrative purposes, the computing system 100 is shown with the first device 102 communicating with the third device 108. However, it is understood that the second device 106 can also communicate with the third device 108 in a similar manner as the communication between the first device 102 and the second device 106.

For brevity of description in this embodiment of the present invention, the third device 108 will be described as a client device. The embodiment of the present invention is not limited to this selection for the type of devices. The selection is an example of an embodiment of the present invention.

The third device 108 can be optimized for implementing an embodiment of the present invention in a multiple device or multiple user embodiments with the first device 102. The third device 108 can provide the additional or specific functions compared to the first device 102, the second device 106, or a combination thereof. The third device 108 can further be a device owned or used by a separate user different from the user of the first device 102. The third device 108 can include a third control unit 634, a third communication unit 636, and a third user interface 638.

The third user interface 638 allows the user (not shown) or the separate user to interface and interact with the third device 108. The third user interface 638 can include an input device and an output device. Examples of the input device of the third user interface 638 can include a keypad, a touchpad, touch screen, soft-keys, a keyboard, a microphone, or any combination thereof to provide data and communication inputs. Examples of the output device of the third user interface 638 can include a third display interface 640. The third display interface 640 can include a display, a projector, a video screen, a speaker, or any combination thereof.

The third control unit 634 can execute a third software 642 to provide the intelligence of the third device 108 of the computing system 100. The third software 642 can operate in conjunction with the first software 526, the second software 542 of FIG. 5, or a combination thereof. The third control unit 634 can provide additional performance compared to the first control unit 512.

The third control unit 634 can operate the third user interface 638 to display information. The third control unit 634 can also execute the third software 642 for the other functions of the computing system 100, including operating the third communication unit 636 to communicate with the first device 102, the second device 106, or a combination thereof over the communication path 104.

The third control unit 634 can be implemented in a number of different manners. For example, the third control unit 634 can be a processor, an application specific integrated circuit (ASIC), an embedded processor, a microprocessor, hardware control logic, a hardware finite state machine (FSM), a digital signal processor (DSP), or a combination thereof.

The third control unit 634 can include a third controller interface 644. The third controller interface 644 can be used for communication between the third control unit 634 and other functional units in the third device 108. The third controller interface 644 can also be used for communication that is external to the third device 108.

The third controller interface 644 can receive information from the other functional units or from external sources, or can transmit information to the other functional units or to external destinations. The external sources and the external destinations refer to sources and destinations external to the third device 108.

The third controller interface 644 can be implemented in different ways and can include different implementations depending on which functional units or external units are being interfaced with the third controller interface 644. For example, the third controller interface 644 can be implemented with a pressure sensor, an inertial sensor, a microelectromechanical system (MEMS), optical circuitry, waveguides, wireless circuitry, wireline circuitry, or a combination thereof.

A third storage unit 646 can store the third software 642. The third storage unit 646 can also store the such as data representing incoming images, data representing previously presented image, sound files, or a combination thereof. The third storage unit 646 can be sized to provide the additional storage capacity to supplement the first storage unit 514.

For illustrative purposes, the third storage unit 646 is shown as a single element, although it is understood that the third storage unit 646 can be a distribution of storage elements. Also for illustrative purposes, the computing system 100 is shown with the third storage unit 646 as a single hierarchy storage system, although it is understood that the computing system 100 can have the third storage unit 646 in a different configuration. For example, the third storage unit 646 can be formed with different storage technologies forming a memory hierarchal system including different levels of caching, main memory, rotating media, or off-line storage.

The third storage unit 646 can be a volatile memory, a nonvolatile memory, an internal memory, an external memory, or a combination thereof. For example, the third storage unit 646 can be a nonvolatile storage such as non-volatile random access memory (NVRAM), Flash memory, disk storage, or a volatile storage such as static random access memory (SRAM).

The third storage unit 646 can include a third storage interface 648. The third storage interface 648 can be used for communication between other functional units in the third device 108. The third storage interface 648 can also be used for communication that is external to the third device 108.

The third storage interface 648 can receive information from the other functional units or from external sources, or can transmit information to the other functional units or to external destinations. The external sources and the external destinations refer to sources and destinations external to the third device 108.

The third storage interface 648 can include different implementations depending on which functional units or external units are being interfaced with the third storage unit 646. The third storage interface 648 can be implemented with technologies and techniques similar to the implementation of the third controller interface 644.

The third communication unit 636 can enable external communication to and from the third device 108. For example, the third communication unit 636 can permit the third device 108 to communicate with the first device 102, the second device 106, or a combination thereof over the communication path 104.

The third communication unit 636 can also function as a communication hub allowing the third device 108 to function as part of the communication path 104 and not limited to be an end point or terminal unit to the communication path 104. The third communication unit 636 can include active and passive components, such as microelectronics or an antenna, for interaction with the communication path 104.

The third communication unit 636 can include a third communication interface 650. The third communication interface 650 can be used for communication between the third communication unit 636 and other functional units in the third device 108. The third communication interface 650 can receive information from the other functional units or can transmit information to the other functional units.

The third communication interface 650 can include different implementations depending on which functional units are being interfaced with the third communication unit 636. The third communication interface 650 can be implemented with technologies and techniques similar to the implementation of the third controller interface 644.

The first communication unit 516 can couple with the communication path 104 to send information to the third device 108 in the first device transmission 508. The third device 108 can receive information in the third communication unit 636 from the first device transmission 508 of the communication path 104.

The third communication unit 636 can couple with the communication path 104 to send information to the first device 102 in the third device transmission 610. The first device 102 can receive information in the first communication unit 516 from the third device transmission 610 of the communication path 104. The computing system 100 can be executed by the first control unit 512, the third control unit 634, or a combination thereof. The second device 106 can similarly communicate and interact with the third device 108 using the corresponding units and functions therein.

For illustrative purposes, the third device 108 is shown with the partition having the third user interface 638, the third storage unit 646, the third control unit 634, and the third communication unit 636, although it is understood that the third device 108 can have a different partition. For example, the third software 642 can be partitioned differently such that some or all of its function can be in the third control unit 634 and the third communication unit 636. Also, the third device 108 can include other functional units not shown in FIG. 6 for clarity.

The functional units in the third device 108 can work individually and independently of the other functional units. The third device 108 can work individually and independently from the first device 102, the second device 106, and the communication path 104.

For illustrative purposes, the computing system 100 is described by operation of the first device 102 and the third device 108. It is understood that the first device 102, the second device 106, and the third device 108 can operate any of the modules and functions of the computing system 100.

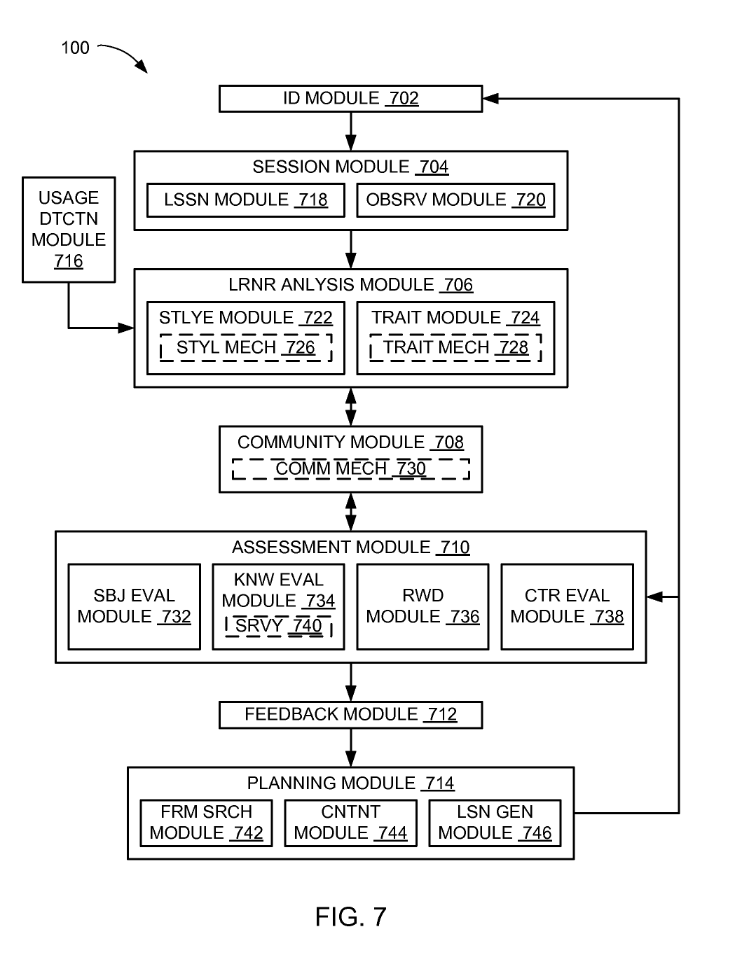

Referring now to FIG. 7, therein is shown a control flow of the computing system 100. The computing system 100 can include an identification module 702, a session module 704, a learner analysis module 706, a community module 708, an assessment module 710, a feedback module 712, a planning module 714, and a usage detection module 716.

The identification module 702 can be coupled to the session module 704 using wired or wireless connections, by having an output of one module as an input of the other module, by having operations of one module influence operation of the other module, or a combination thereof. Similarly, the session module 704 and the usage detection module 716 can be couple to the learner analysis module 706, and the learner analysis module 706 can be coupled to the community module 708. Moreover, the community module 708 can be coupled to the assessment module 710, and the assessment module 710 can be coupled to the feedback module 712. Likewise, the feedback module 712 can be coupled to the planning module 714, and the planning module 714 can be further coupled to the identification module 702.

The identification module 702 is configured to identify the user. The identification module 702 can identify the user by collecting information regarding the user.

The identification module 702 can display, prompt for, receive, or a combination thereof for the information regarding the user with the profile portion 302 of FIG. 3. The identification module 702 can use the first user interface 518 of FIG. 5, the second user interface 538 of FIG. 5, the third user interface 638 of FIG. 6, or a combination thereof to generate and display the profile portion 302.

For example, the identification module 702 can identify the user by displaying a log-in screen, receiving the user's identification information, verifying the user's identification information, or a combination thereof. Also for example, the identification module 702 can identify the user by displaying a screen or a series of prompts for gathering information corresponding to the learner profile 308 of FIG. 3.

As a more specific example, the identification module 702 can identify the user by using the profile portion 302 to receive the identification information 310 of FIG. 3, the learning style 312 of FIG. 3, the learning goal 314 of FIG. 3, the learner trait 316 of FIG. 3, or a combination thereof. Also as a more specific example, the identification module 702 can identify the user by using the profile portion 302 to collect information excluding the learning style 312, the learning goal 314, the learner trait 316, or a combination thereof.

As a further example, the identification module 702 can identify the user by displaying the learner profile 308. As a more specific example, the identification module 702 can display the identification information 310, such as a log-in name or the user's name, the learner schedule calendar 318 of FIG. 3, the learning goal 314, or a combination thereof.

The identification module 702 can further identify information associated with the user. The identification module 702 can identify the subject matter 204 of FIG. 2, the subject category 206 of FIG. 2, the mastery level 208 of FIG. 2, the learning session 210 of FIG. 2, the mastery reward 244 of FIG. 2, the learner knowledge model 322 of FIG. 3, the learning community 330 of FIG. 3, the external entity 402 of FIG. 4, or a combination thereof associated with the user.

The identification module 702 can use the first control unit 512 of FIG. 5, the second control unit 534 of FIG. 5, the third control unit 634 of FIG. 6, or a combination thereof to search for information belonging to or associated with the user. The identification module 702 can search the first storage unit 514 of FIG. 5, the second storage unit 546 of FIG. 5, the third storage unit 646 of FIG. 6, or a combination thereof for the information matching or containing the user's log-in name, user's name, identification, or a combination thereof to identify information associated with the user.

The identification module 702 can further identify information associated with the user by communicating the user information between devices. The identification module 702 can use the first communication unit 516 of FIG. 5, the second communication unit 536 of FIG. 5, the third communication unit 636 of FIG. 6, or a combination thereof to send, receive, or a combination thereof for the identification information 310 of the user between the first device 102 of FIG. 1, the second device 106 of FIG. 1, the third device 108 of FIG. 1, or a combination thereof.

After identifying the user, the control flow can pass from the identification module 702 to the session module 704. The control flow can pass by having user response to or through the profile portion 302, the identification information 310, information associated thereto, or a combination thereof as an output from the identification module 702 to the session module 704, storing the user response to or through the profile portion 302, the identification information 310, information associated thereto, or a combination thereof at a location known and accessible to the session module 704, by notifying the session module 704, such as by using a flag, an interrupt, a status signal, or a combination thereof, or a combination of processes thereof.

The session module 704 is configured to facilitate the learning session 210 for the user. The session module 704 can facilitate the learning session 210 through the management platform 202 of FIG. 2.

The session module 704 can identify the learning session 210 corresponding to the identification information 310 of the user. The session module 704 can recall the instance of the learning session 210, the subject matter 204, or a combination thereof appropriate for the user based on a current time, a current location, a current context, a learning schedule, or a combination thereof. The session module 704 can include a lesson module 718, an observation module 720, or a combination thereof for implementing the learning session 210.

The lesson module 718 is configured to adjust the management platform 202 for facilitating the learning session 210. The lesson module 718 can facilitate the learning session 210 by using the first user interface 518, the second user interface 538, the third user interface 638, or a combination thereof to display, audibly recreate, receive, or a combination thereof for the lesson portion 258 of FIG. 2 of the learning session 210.

For example, the lesson module 718 can adjust the lesson portion 258 to display or audibly recreate the lesson frame 212 of FIG. 2, the lesson content 216 of FIG. 2, the assessment component 218 of FIG. 2 or the common error 240 of FIG. 2 therein, or a combination thereof. Also for example, the lesson module 718 can control one or more devices within the computing system 100 according to the ambient simulation profile 242 of FIG. 2.

For further example, the lesson module 718 can receive and identify user-provided information through the lesson portion 258 as the learner response 220 of FIG. 2. The lesson module 718 can identify the learner response 220 as user's interaction in the lesson portion 258, or based on the learning session 210, a timing related to the assessment component 218, based on a location of the user's interaction or information, or a combination thereof, having a specified format or identifier, or a combination thereof.

The observation module 720 is configured to determine information associated with the learner response 220 or the learning session 210. The observation module 720 can determine the response evaluation factor 222 of FIG. 2 associated with the learner response 220.

For example, the observation module 720 can determine the response evaluation factor 222 including the component description 226 of FIG. 2, the assessment format 228 of FIG. 2, the answer rate 230 of FIG. 2, the contextual parameter 232 of FIG. 2, the physical indication 234 of FIG. 2, or a combination thereof. As a more specific example, the observation module 720 can determine the response evaluation factor 222 by using the first control interface 522 of FIG. 5, the second control interface 544 of FIG. 5, the third control interface 644 of FIG. 6, the first communication unit 516, the second communication unit 536, the third communication unit 636, or a combination thereof to access the identification information of the lesson frame 212, the lesson content 216, the assessment component 218, or a combination thereof stored in the first storage unit 514, the second storage unit 546, the third storage unit 646, or a combination thereof to determine the component description 226.

Also as a more specific example, the observation module 720 can determine the response evaluation factor 222 by using a similar set of units to identify the assessment format 228 stored in one or more of the storage units corresponding to the assessment component 218. The observation module 720 can further identify the assessment format 228 by using the first control unit 512, the second control unit 534, the third control unit 636, or a combination thereof to compare the assessment component 218 to formats or templates predetermined by the computing system 100 or the external entity 402.

Also as a more specific example, the observation module 720 can determine the response evaluation factor 222 by using the first user interface 518, the second user interface 538, the third user interface 638, the first control unit 512, the second control unit 534, the third control unit 636 or a combination thereof to determine the answer rate 230. The observation module 720 can determine the answer rate 230 by measuring time or clock cycles between displaying the assessment component 218 and receiving or identifying the learner response 220 to the assessment component 218.

Also as a more specific example, the observation module 720 can determine the response evaluation factor 222 by using the first control unit 512, the second control unit 534, the third control unit 636, the location unit 520 of FIG. 5, the interface units thereof, or a combination thereof to determine the contextual parameter 232. The observation module 720 can determine contextual parameter 232 by identifying a current time, a current date, a current location, an event name or a significance associated thereto, a person or a device within a predetermined distance from the user or a user's device, such as the first device 102 or the third device, a current weather, or a combination thereof.

Continuing with the example, the observation module 720 can further search a user data, such as the learner schedule calendar 318, a correspondence, a note, or a combination thereof for keywords associated with the current time, the current date, the current location, identity or ownership of the person or the device within the predetermined distance, as predetermined by the computing system 100, or a combination thereof to determine the contextual parameter 232. The observation module 720 can use the first user interface 518, the second user interface 538, the third user interface 638, or a combination thereof to determine the contextual parameter 232, such as by identifying a background-noise level or detecting a lighting condition.

Also as a more specific example, the observation module 720 can determine the response evaluation factor 222 by using one or more of the interface units, one or more of the control units, or a combination thereof to identify the physical indication 234. The observation module 720 can use a camera and an image processor to identify a key physical feature, such as the user's eyes, head, body, face, or a combination thereof.

Continuing with the example, the observation module 720 can further determine a user behavior, such as an eye movement, a head movement, an orientation for the head, an orientation for the body, a posture, a pattern thereof, or a combination thereof associated with the key physical feature using the image processor. The observation module 720 can determine the user behavior by comparing the key physical feature or a sequence thereof to a set of patterns, a set of ranges, or a combination thereof predetermined by the computing system 100 for identifying nodding, nervous behavior, distracted behavior, drowsy behavior, or a combination thereof.

Also as a more specific example, the observation module 720 can determine the response evaluation factor 222 by communicating the response evaluation factor 222 between devices. The observation module 720 can use the first communication unit 516, the second communication unit 536, the third communication unit 636, or a combination thereof to send, receive, or a combination thereof for the response evaluation factor 222 between the first device 102, the second device 106, the third device 108, or a combination thereof.

The session module 704 can record information associated with the learning session 210 to create or update the learner history 320 of FIG. 3. The session module 704 can record the component description 226, the assessment component 218, the learner response 220, other information included in the response evaluation factor 222, the ambient simulation profile 242, or a combination thereof for the learner history 320. The session module 704 can further record the time, the location, the device used, the subject matter 204, or a combination thereof corresponding to the learning session 210.

After facilitating the learning session 210, the control flow can pass from the session module 704 to the learner analysis module 706. The control flow can pass similarly as described above between the identification module 702 and the session module 704.

The usage detection module 716 can similarly provide information, control, or a combination thereof to the learner analysis module 706. The usage detection module 716 is configured to detect user information external to the management platform 202. The usage detection module 716 can determine the device-usage profile 410 of FIG. 4 including the platform-external usage 414 of FIG. 4. The usage detection module 716 can determine the device-usage profile 410 for characterizing the platform-external usage 414 of one or more devices in the computing system 100.

The usage detection module 716 can determine the device-usage profile 410 by recording, analyzing, filtering, or a combination thereof for data obtained by the first device 102, the second device 106, the third device 108, or a combination thereof. The usage detection module 716 can record, analyze, filter, or a combination thereof for data obtained through the first user interface 518, the second user interface 538, the third user interface 638, the first communication unit 516, the second communication unit 536, the third communication unit 636, the location unit 520, or a combination thereof.

For example, the usage detection module 716 can use a camera to visually observe the user, a microphone to listen to the user, the location unit 520 to identify the current location of the user, or a combination thereof. Also for example, the usage detection module 716 can identify usage of key words associated with the subject matter 204 during a phone call, in a writing, such as a spread sheet or an email, identify demonstration or usage of the subject matter 204 in the user's movement observed through the camera, the location unit 520, or a combination thereof.

The computing system 100 can further identify or determine usage or application of the subject matter 204 from the platform-external usage 414, evaluate the platform-external usage 414, or a combination thereof. Details regarding the further processing of the platform-external usage 414 will be described below.

After detecting the platform-external usage 414, the control flow can pass from the usage detection module 716 to the learner analysis module 706. The control flow can pass similarly as described above between the identification module 702 and the session module 704.

The learner analysis module 706 is configured to determine information regarding the user. The learner analysis module 706 can determine information regarding the user associated with learning information.

The learner analysis module 706 can collect the data from the identification module 702, the session module 704, or a combination to initialize, adjust, or a combination thereof for the response evaluation factor 222, the learner profile 308, or a combination thereof. For example, the learner analysis module 706 can adjust or finalize the response evaluation factor 222 by determining, including, or a combination thereof for the learner focus level 236 of FIG. 2, the error cause estimate 238 of FIG. 2, or a combination thereof.

Also for example, the learner analysis module 706 can initialize the learner profile 308 with directed information for identifying learner traits or characteristics, such as specific prompts associated with or through a survey, including the identification information 310, the learning style 312, the learning goal 314, the learner trait 316, or a combination thereof. For further example, the learner analysis module 706 can determine or adjust the learning style 312, the learner trait 316, or a combination thereof using indirect information, such as using the learner response 220, the response evaluation factor 222, the device-usage profile 410, the platform-external usage 414, or a combination thereof.

The learner analysis module 706 can determine information regarding the user by determining the response evaluation factor 222 or a portion therein, the learner profile 308 or a portion therein, or a combination thereof. For example, the learner analysis module 706 can determine information associated with one instance of the learning session 210 through the response evaluation factor 222, including the learner focus level 236, the error cause estimate 238, or a combination thereof.

As a more specific example, the learner analysis module 706 can use a threshold or a range, such as for noise level or brightness, a known pattern or a behavioral indicator, or a combination thereof predetermined by the computing system 100 or the external entity 402 in comparison to a different aspect of the response evaluation factor 222, such as the contextual parameter 232 or the physical indication 234, for identifying the error cause estimate 238. Also as a more specific example, the learner analysis module 706 can use a threshold or a range, a process or a method, including an equation or a sequence of steps, a weight factor, or a combination thereof to quantize and combine one or more aspects of the response evaluation factor 222 to calculate the learner focus level 236.

Also for example, the learner analysis module 706 can determine general information associated with the user's learning activities through the learner profile 308 or a portion therein, including the learning style 312, the learning goal 314, the learner trait 316, or a combination thereof. The learner analysis module 706 can include a style module 722, a trait module 724, or a combination thereof for determining the general information associated with the user's learning activities.

The style module 722 is configured to determine the learning style 312 of the user. The style module 722 can determine the learning style 312 by using the first control unit 512, the second control unit 534, the third control unit 634, or a combination thereof to determine a pattern, a cluster, a model, or a combination thereof in the subject matter 204, the learner response 220, the response evaluation factor 222, the device-usage profile 410, the platform-external usage 414, or a combination thereof. The style module 722 can use the first storage interface 524 of FIG. 5, the second storage interface 548 of FIG. 5, the third storage interface 648 of FIG. 6, or a combination thereof to compare the pattern, the cluster, the model, or a combination thereof identifying categories or values for the learning style 312.

For example, the style module 722 can include a learning-style mechanism 726 for defining and identifying instances of the pattern, the cluster, the model, or a combination thereof characteristic of various instances of values of the learning style 312. Also for example, the learning-style mechanism 726 can further include a process or an equation, a weight factor, a threshold, a range, a sequence thereof, or a combination thereof for quantizing, evaluating, and identifying the pattern, the cluster, the model, or a combination thereof.

The style module 722 can include the learning-style mechanism 726 provided by the computing system 100, the external entity 402, or a combination thereof. The style module 722 can further update the learning-style mechanism 726 using the first communication unit 516, the second communication unit 536, the third communication unit 636, or a combination thereof. The style module 722 can further update or adjust the learning-style mechanism 726 based on processing of the community module 708, described in detail below.

The style module 722 can process the pattern, the cluster, the model, or a combination thereof in the subject matter 204, the learner response 220, the response evaluation factor 222, the device-usage profile 410, the platform-external usage 414, or a combination thereof according to the learning-style mechanism 726. The style module 722 can assign the corresponding value or result as the learning style 312 of the user.

The trait module 724 is configured to determine the learner trait 316 of the user. The style module 722 can determine the learner trait 316 similar to the process of the style module 722.

The trait module 724 can include a learning-trait mechanism 728 provided by the computing system 100, the external entity 402, or a combination thereof for defining and identifying instances of the pattern the cluster, the model, or a combination thereof characteristic of various instances of values of the learner trait 316. The learning-trait mechanism 728 can include a process or an equation, a weight factor, a threshold, a range, a sequence thereof, or a combination thereof for quantizing, evaluating, and identifying the pattern, the cluster, the model, or a combination thereof for the learner trait 316.

The trait module 724 can determine the pattern, the cluster, the model, or a combination thereof in the subject matter 204, the learner response 220, the response evaluation factor 222, the device-usage profile 410, the platform-external usage 414, or a combination thereof. The trait module 724 can further process the pattern, the cluster, the model, or a combination thereof according to the learning-trait mechanism 728. The trait module 724 can assign the corresponding value or result as the learner trait 316 of the user.

The trait module 724 can further update the learning-trait mechanism 728 using the first communication unit 516, the second communication unit 536, the third communication unit 636, or a combination thereof. The trait module 724 can further update or adjust the learning-trait mechanism 728 based on processing of the community module 708, described in detail below.

After determining information regarding the user, the control flow can pass from the learner analysis module 706 to the community module 708. The control flow can pass similarly as described above between the identification module 702 and the session module 704.

The community module 708 is configured to identify the learning community 330 corresponding to the user. The community module 708 can communicate the learning community 330 using the community portion 306 of FIG. 3

The community module 708 can identify the learning community based on grouping multiple users based on similarities in various parameters. For example, the community module 708 can identify the learning community 330 based on the learner profile 308, the subject matter 204, the learner response 220, the response evaluation factor 222, the learner knowledge model 322, or a combination thereof.

The community module 708 can use the first communication unit 516, the second communication unit 536, the third communication unit 636, the first control unit 512, the second control unit 534, the third control unit 634, or a combination thereof. The community module 708 can identify the learning community 330 as a grouping of users having one or more of values in the learner profile 308 in common.

For example, the community module 708 can identify the learning community 330 as a grouping of users having overlaps in the identification information 310, such as having same age, same gender, residing within a common area, such as a subdivision or a country, residing or located within a threshold distance from each other, same ethnicity, similar education level, similar profession, or a combination thereof. Also for example, the community module 708 can identify the learning community 330 as a grouping of users having similar or same instance of the learning style 312, the learning goal 314, the learner trait 316, the subject category 206, the mastery level 208, or a combination thereof.

For further example, the community module 708 can identify the learning community 330 as a grouping of users using the same instance of the lesson frame 212, the lesson content 216, or a combination thereof. As a further example, the community module 708 can identify the learning community based on same instances of the learner response 220, similarities or overlaps in the response evaluation factor 222, similarities or overlaps in the learner knowledge model 322, or a combination thereof.

The community module 708 can include a community mechanism 730. The community mechanism 730 is a method or a process for identifying the learning community 330.

The community mechanism 730 can include instructions or steps, hardware programming or wiring, or a combination thereof for detecting similarities or overlaps in data associated with various users. The community mechanism 730 can include a hierarchy, a sequence, a threshold, a range, a weight factor, or a combination thereof in detecting similarities or overlaps. The community mechanism 730 can include one or more templates or criteria for identifying the learning community 330 based on different parameters. The community mechanism 730 can include information for identifying the direct connection 332 of FIG. 3, the indirect link 334 of FIG. 3, the learning peer 336 of FIG. 3, the subject tutor 338 of FIG. 3, or a combination thereof.

The community module 708 can compare various parameters associated with one or more remote user to the corresponding parameters of the user using the community mechanism 730. The community module 708 can identify the learning peer 336 as the grouping of remote users having similar or overlapping parameters as that of the user based on the community mechanism 730.

The community module 708 can further identify the direct connection 332 based on searching the device-usage profile 410 for previous communication between the user and the remote user based on the community mechanism 730. The community module 708 can also identify the direct connection 332 based a link between the users in social network profiles, in user's calendar entries, such as for meetings or reminders, in user's contact list, or a combination thereof based on the community mechanism 730. The community module 708 can identify the indirect link 334 when information reflects no connection or previous interaction between the users based on the community mechanism 730.

The community module 708 can further identify the subject tutor 338 based on comparing the mastery level 208 for the subject matter 204, a time associated therewith, membership in the learning community 330 of the user, or a combination thereof. The community module 708 can identify one or more remote users having higher instances of the mastery level 208 for the subject matter 204, having corresponding or common instances of the learner trait 316 or the learning style 312 as the user, rating information for the remote users, an associated time within a threshold, such as time since reaching the mastery level 208 or since last teaching activity, or a combination thereof according to the community mechanism 730.

The community module 708 can further identify the common error 240 corresponding to the assessment component 218. The community module 708 can similarly use the community mechanism 730 to determine analytic information regarding wrong instances of learner response 220 to the assessment component 218. The community module 708 can analyze the wrong instances using statistical analysis, pattern analysis, a machine-learning mechanism, or a combination thereof.

The community module 708 can identify the wrong instance of the learner response 220 matching a criteria predetermined by the computing system 100, the external entity 402, or a combination thereof as the common error 240. The community module 708 can identify most frequently occurring wrong instance, the wrong instance exceeding a threshold, or a combination thereof as the common error 240.

The community module 708 can further identify the learning community 330 based on remote users commonly selecting one or more instances of the common error 240. The community module 708 can also limit the comparison for identifying the common error 240 to within one or more instances of the learning community 330 corresponding to the user.

The community module 708 can pass the learning community 330 to the learner analysis module 706. The learner analysis module 706 can further determine information regarding the user using the learning community 330. For example, the learner analysis module 706 can adjust the learner focus level 236, the error cause estimate 238, or a combination thereof, such as by normalizing or filtering based on corresponding values within the learning community 330. Also for example, the learner analysis module 706 can determine or adjust the learning style 312, the learning goal 314, the learner trait 316, or a combination thereof based on corresponding values within the learning community 330.

After determining the learning community 330, the control flow can pass from the community module 708 to the assessment module 710. The control flow can pass similarly as described above between the identification module 702 and the session module 704.

The assessment module 710 is configured to analyze the knowledge-related information from perspectives of various parties. For example, the assessment module 710 can analyze relationship between various information, effective knowledge or effectiveness of the learning activity for the user, applicable reward, effectiveness of the external entity 402 with respect to the user, or a combination thereof. The assessment module 710 can include a subject evaluation module 732, a knowledge evaluation module 734, a reward module 736, a contributor evaluation module 738, or a combination thereof for analyzing the knowledge-related information.

The subject evaluation module 732 is configured to analyze relationship between various instances of information. The subject evaluation module 732 can determine the subject connection model 348 of FIG. 3. The subject evaluation module 732 can determine the subject connection model 348 corresponding to the subject matter 204, the lesson content 216, the assessment component 218, or a combination thereof.

The subject evaluation module 732 can determine the subject connection model 348 based on analyzing keywords. For example, the subject evaluation module 732 can identify the subject connection model 348 based on clusters, distance between clusters, or a combination thereof.

Also for example, the subject evaluation module 732 can have a hierarchy and a corresponding weight factor for levels of detail regarding instances of the subject matter 204, the subject category 206, sub-levels thereof, or a combination thereof. The subject evaluation module 732 can use an equation or a process for combining and evaluating the weights between instances of the subject matter 204.

As a more specific example, the subject evaluation module 732 can determine “French Language” and “French History” based on clustering with keywords used in identifying the instances of the subject matter 204 or the subject category 206, used in describing the subject matter 204, the subject category 206, the learning session 210, or a combination thereof, used in communicating the assessment component 218, or a combination thereof. Also as a more specific example, the subject evaluation module 732 can determine that “multi-digit multiplication” includes “addition” based on evaluating the weights associated with the concepts.

The subject evaluation module 732 can calculate a distance or a product of the weights between instances of the subject matter 204. The subject evaluation module 732 can determine the subject connection model 348 as a collection of instances for the subject matter 204 having the distance or the product satisfying a threshold value. The subject evaluation module 732 can further determine the distance or the product as an arbitrary description of a degree of relationship between instances of the subject matter 204.

The subject evaluation module 732 can use the method or the process, the threshold, the weights, or a combination thereof predetermined by the computing system 100, the external entity 402, or a combination thereof. The subject evaluation module 732 can further receive inputs and adjustments for determining the subject connection model 348 by searching relevant information available on the internet or a database, or by receiving information or adjustment from the external entity 402.

The knowledge evaluation module 734 is configured to analyze the effective knowledge of the user. The knowledge evaluation module 734 can generate or adjust the learner knowledge model 322 including the mastery level 208 for one or more instances of the subject matter 204. The knowledge evaluation module 734 can communicate the learner knowledge model 322 through the knowledge model portion 304 of FIG. 3.

The knowledge evaluation module 734 can generate or adjust the learner knowledge model 322, calculate the mastery level 208, or a combination thereof based on a variety of information. For example, the knowledge evaluation module 734 can use the learner response 220, the response evaluation factor 222, the learner profile 308, or a combination thereof. Also as an example, the knowledge evaluation module 734 can use the subject matter 204, the learning session 210, the learning community 330, or a combination thereof.

As a more specific example, the knowledge evaluation module 734 can use the response accuracy 224 of FIG. 2, the component description 226, the assessment format 228, the answer rate 230, the contextual parameter 232, the physical indication 234, the learner focus level 236, the error cause estimate 238, the common error 240, the ambient simulation profile 242, or a combination thereof. Also as a more specific example, the knowledge evaluation module 734 can use the learning style 312, the learning goal 314, the learner trait 316, the learner history 320, or a combination thereof.

Further, as a more specific example, the knowledge evaluation module 734 can use the direct connection 332, the indirect link 334, the learning peer 336, information associated therewith, or a combination thereof. Also as a more specific example, the knowledge evaluation module 734 can use the device-usage profile 410 including the platform-external usage 414, the contextual overlap 416 of FIG. 4, the usage significance 418 of FIG. 4, or a combination thereof.

The knowledge evaluation module 734 can generate the learner knowledge model 322 by calculating the mastery level 208 for one or more instances of the subject matter 204 encountered by the user. The knowledge evaluation module 734 can determine the starting point 324 of FIG. 3 with the subject matter 204 encountered by the user and the corresponding instance of the mastery level 208 using a survey 740 or an assessment test. The knowledge evaluation module 734 can adjust, such as by adding instances of the subject matter 204 or by changing the mastery level 208 for the starting point 324, based on a result of the learning session 210, the platform-external usage 414, or a combination thereof.

The knowledge evaluation module 734 can further generate the learner knowledge model 322 without the survey or the assessment test. The knowledge evaluation module 734 can determine the starting point 324 based on instances of the learner knowledge model 322 for the learning community 330. The knowledge evaluation module 734 can further determine the starting point 324 based on first instance of the learning session 210.

The knowledge evaluation module 734 can generate or adjust the learner knowledge model 322 based on the subject connection model 348. The knowledge evaluation module 734 can calculate the mastery level 208 for the subject matter 204 based on the result of the learning session 210, such as using the learner response 220 or the response evaluation factor 222.

The knowledge evaluation module 734 can use the mastery level 208 for the subject matter 204 to include other instances of the subject matter 204 connected to the analyzed instance of the subject matter 204 in the learner knowledge model 322. The knowledge evaluation module 734 can calculate the mastery level 208 for the other instances of the subject matter 204, such as by scaling with the distance or the weight associated between instances of the subject matter 204, based on the analyzed instance of the mastery level 208.

The knowledge evaluation module 734 can adjust the learner knowledge model 322 or the mastery level 208 by comparing the learning style 312, the learner trait 316, or a combination thereof to the lesson frame 212. For example, incremental change in the mastery level 208 resulting from one instance of the learning session 210 can be adjusted higher when the user scores high in the learning session 210 despite the learning style 312 not matching the lesson frame 212, when the learner trait 316 indicates a weakness in the subject matter 204, or a combination thereof. Also for example, the incremental change in the mastery level 208 can be adjusted lower when the lesson frame 212 matches the learning style 312, when the learner trait 316 indicates a strength in the subject matter 204, or a combination thereof.

The knowledge evaluation module 734 can adjust the learner knowledge model 322 or the mastery level 208 based on the assessment format 228. The knowledge evaluation module 734 can calculate the difficulty rating 346 of FIG. 3 associated with the lesson content 216, the assessment format 228, or a combination thereof. The knowledge evaluation module 734 can adjust the incremental change in the mastery level 208 based on the difficulty rating 346, the result of the learning session 210, or a combination thereof.

For example, the knowledge evaluation module 734 can increase the incremental adjustment when the user gets an essay project or a fill-in-the-blank question correct, decrease the incremental adjustment when the user gets a multiple choice question correct, or a combination thereof. Also for example, the knowledge evaluation module 734 can decrease a negative effect on the incremental adjustment when the user answers the essay project or the fill-in-the-blank question incorrect, increase the negative effect when the user answers the multiple choice question incorrect, or a combination thereof.

The knowledge evaluation module 734 can adjust the learner knowledge model 322 or the mastery level 208 based on the contextual parameter 232, the physical indication 234, the error cause estimate 238, the learner focus level 236, or a combination thereof. For example, the knowledge evaluation module 734 can adjust based on comparing the contextual parameter 232 or an event occurring prior to the learning session 210 and a psychological model. The knowledge evaluation module 734 can adjust based on an impact level of the contextual parameter 232 or the event according to the psychological model.

Also for example, the knowledge evaluation module 734 can adjust based on comparing the contextual parameter 232, the physical indication 234, the error cause estimate 238, the learner focus level 236, or a combination thereof to the learner history 320. The knowledge evaluation module 734 can adjust based on identifying new instance of the contextual parameter 232 in combination with the physical indication 234, the error cause estimate 238, the learner focus level 236, or a combination thereof in comparison to the learner history 320. The knowledge evaluation module 734 can further adjust based on comparing a pattern, a cluster, a model, or a combination thereof in the learner history 320 to the contextual parameter 232, the physical indication 234, the error cause estimate 238, the learner focus level 236, or a combination thereof for the analyzed instance of the learning session 210.

As a more specific example, the knowledge evaluation module 734 can adjust the incremental change for the mastery level 208 to be lower for wrong answers or higher for correct answers when the user is in a new environment or is nearby unknown or rarely seen people. Also as a more specific example, the knowledge evaluation module 734 can adjust the incremental change if the user has a history of scoring higher when a parent is nearby, as indicated by the contextual parameter 232.

The knowledge evaluation module 734 can adjust based on the learning community 330. The knowledge evaluation module 734 can normalize the incremental adjustment based on results from same or similar instances of the learning session 210 or the subject matter 204 in the learning community 330.

The knowledge evaluation module 734 can further adjust based on the learning community 330 using the common error 240. The knowledge evaluation module 734 can decrease the incremental change in the mastery level 208 when the user repeats the common error 240. The knowledge evaluation module 734 can further adjust the mastery level 208 when the learner history 320 shows a pattern of repeating the common error 240. The knowledge evaluation module 734 can increase the incremental change when the response accuracy 224 is correct despite having the common error 240 associated with the assessment component 218.

The knowledge evaluation module 734 can further adjust based on the device-usage profile 410. The knowledge evaluation module 734 can implement or include a match filter or a template, such as for keywords, for patterns of movement or data, for a sequence of sounds, or a combination thereof associated with the subject matter 204 for the device-usage profile 410 or real-time input data into the usage detection module 716. For example, the knowledge evaluation module 734 can include the match filter or the template for identifying vocabulary word, a mathematical concept or pattern, a movement pattern for physical indicators corresponding to the user, or a combination thereof.

The knowledge evaluation module 734 can identify the platform-external usage 414 as being associated with the subject matter 204 when the device-usage profile 410 for previously occurring data or real-time input data matches the match filter or the template, or is within a threshold range associated with the match filter or the template. The knowledge evaluation module 734 can further analyze the platform-external usage 414 based on its association to the subject matter 204.

For example, the knowledge evaluation module 734 can determine the contextual overlap 416 between the subject matter 204 and the platform-external usage 414, an accuracy associated with the platform-external usage 414 in light of the subject matter 204, the usage significance 418, or a combination thereof. The knowledge evaluation module 734 can analyze the data occurring before, after, concurrently with, or a combination thereof for the platform-external usage 414 associated with the subject matter 204.

For example, the knowledge evaluation module 734 can analyze the words before and after the keyword. Also for example, the knowledge evaluation module 734 can determine a context based on location, time, associated event, surrounding people, source, or a combination thereof before, after, during the occurrence of the platform-external usage 414 associated with the subject matter 204.

The knowledge evaluation module 734 can use the sequence of data to determine the contextual overlap 416, the accuracy, the usage significance 418, or a combination thereof. For example, the knowledge evaluation module 734 can evaluate the accuracy based on sentence structure, context, spelling or a combination thereof for the keyword based on recognizing a sentence using the words surrounding the keyword.

Also for example, the knowledge evaluation module 734 can compare the contextual evaluation with the subject matter 204, such as using clustering or pattern analysis, to determine the contextual overlap 416. For further example, the knowledge evaluation module 734 can determine the usage significance 418 based on a format of the data, the source of the data, or a combination thereof. As a more specific example, the data sourced external to the user can have a lower value for the usage significance 418 than data sourced by the user.

The knowledge evaluation module 734 can also analyze the platform-external usage 414 associated with the subject matter 204 based on the learner history 320. The knowledge evaluation module 734 can compare the platform-external usage 414 to previous instances of the learning session 210 involving the subject matter 204.

The knowledge evaluation module 734 can determine the contextual overlap 416 based on a number of reoccurring keywords, similarity in patterns, a distance between clusters, or a combination thereof in comparison to the corresponding instances of the learning session 210 in the learner history 320. The knowledge evaluation module 734 can similarly determine the accuracy and the usage significance 418 for the platform-external usage 414.

The knowledge evaluation module 734 can determine an incremental adjustment to the mastery level 208 based on the accuracy, the contextual overlap 416, the usage significance 418, or a combination thereof for the platform-external usage 414 associated with the subject matter 204. The knowledge evaluation module 734 can include a process or an equation predetermined by the computing system 100 or the external entity 402 for calculating the incremental adjustment based on the accuracy, the contextual overlap 416, the usage significance 418, or a combination thereof.

The knowledge evaluation module 734 can apply the incremental adjustment to the mastery level 208 corresponding to the subject matter to generate or adjust the learner knowledge model 322. The knowledge evaluation module 734 can further analyze the instances of the incremental adjustment in the learner history 320, the device-usage profile 410, or a combination thereof to calculate the learning rate 326 of FIG. 3, determine the learner-specific pattern 328 of FIG. 3, or a combination thereof.

The knowledge evaluation module 734 can similarly use machine learning processes or pattern analysis processes to determine calculate the learning rate 326, determine the learner-specific pattern 328, or a combination thereof. The knowledge evaluation module 734 can include a process, a parameter, a threshold, a template, or a combination thereof predetermined by the computing system 100 or the external entity 402 for calculating the learning rate 326, determining the learner-specific pattern 328, or a combination thereof based on the learner history 320, the device-usage profile 410, or a combination thereof.

The knowledge evaluation module 734 can further determine a possible cheating scenario. The knowledge evaluation module 734 can determine the possible cheating scenario based on detecting an above-average instance of increase in the mastery level 208 based on the learner history 320 or the learning community 330, along with contextual information for people, devices, resources, or a combination thereof nearby the user or accessed by the user.

For example, the knowledge evaluation module 734 can determine the possible cheating scenario based on determining a pattern of above-average score whenever a specific person is nearby the user. Also for example, the knowledge evaluation module 734 can determine the possible cheating scenario based on website address or chatting application accessed during the learning session 210.

For further example, the knowledge evaluation module 734 can determine the possible cheating scenario or an abnormal usage based on the answer rate 230. The knowledge evaluation module 734 can indicate the abnormal usage or the possible cheating scenario when the answer rate 230 is outside of a threshold range, less than or greater than a threshold value, or a combination thereof. The threshold range or the threshold value can be based on the user's learning history, values corresponding to the learning community, or a combination thereof, such as for average rate. The threshold range or the threshold value can further be predetermined by the computing system 100 or calculated using a method or an equation predetermined by the computing system 100.

For example, the abnormal usage indicating user's hastiness can be determined when the answer rate 230 is below the threshold amount from the user's average time determined using the predetermined method. Also for example, the abnormal usage indicating user's distracted behavior can be similarly be determined when the answer rate 230 is above the threshold amount. Also for example, the possible cheating scenario can be determined when the answer rate 230 is outside of the threshold range corresponding to the mastery level 208 of the user, the learning community, or a combination thereof, and the user scores above an average score from the user's history or the learning community.

The knowledge evaluation module 734 can use the first control interface 522, the second control interface 544, the third control interface 644, or a combination thereof to access the necessary data in generating and adjusting the learner knowledge model 322. The knowledge evaluation module 734 can use the first control unit 512, the second control unit 534, the third control unit 634, or a combination thereof to compare, calculate, analyze, determine, or a combination thereof for generating and adjusting the learner knowledge model 322. The knowledge evaluation module 734 can store the learner knowledge model 322 in the first storage unit 514, the second storage unit 546, the third storage unit 646, or a combination thereof.

The reward module 736 is configured to generate the mastery reward 244 based on the learner knowledge model 322. The reward module 736 can generate the mastery reward 244 using the first user interface 518, the second user interface 538, the third user interface 638, or a combination thereof through the reward portion 260 of FIG. 2. The reward module 736 can generate the mastery reward 244 by displaying a coupon or a certificate, allowing access to a link or a feature, sending or receiving an email or information, or a combination thereof.

The reward module 736 can use the first communication unit 516, the second communication unit 536, the third communication unit 636, or a combination thereof. The reward module 736 can communicate the mastery reward 244 between the first device 102, the second device 106, the third device 108, or a combination thereof.

The reward module 736 can compare the mastery level 208 of the subject matter 204 to a requirement associated with the mastery reward 244. The reward module 736 can generate the mastery reward 244 when the mastery level 208 meets the requirement associated with the mastery reward 244.

The contributor evaluation module 738 is configured to analyze the effectiveness of the external entity 402 with respect to the user. The contributor evaluation module 738 can evaluate various components of the learning session 210, including the lesson frame 212, the lesson content 216, the ambient simulation profile 242, the mastery reward 244, or a combination thereof.

The contributor evaluation module 738 can evaluate the various components using the learner history 320, the learner profile 308, the learner knowledge model 322, or a combination thereof. The contributor evaluation module 738 can determine a cluster, a pattern, a model, an aberration, or a combination thereof based on the learner history 320, the learner profile 308, the learner knowledge model 322, or a combination thereof with respect to the external entity 402 and the user.

The contributor evaluation module 738 can further analyze the external entity 402 across the learning community 330 to determine the cluster, the pattern, the model, the aberration, or a combination thereof. For example, the contributor evaluation module 738 can positively rate the external entity 402 when the cluster, the pattern, the model, the aberration, or a combination thereof indicates higher than average increase in improvement for the mastery level 208 following the learning session 210 or a component therein. Also for example, the contributor evaluation module 738 can positively rate the external entity 402 based on a number of access, popularity, user rating, or a combination thereof.

The contributor evaluation module 738 can determine the external-entity assessment 406 of FIG. 4 for evaluating the external entity 402. The contributor evaluation module 738 can determine the external-entity assessment 406 as the result of the assessment based on the learner knowledge model 322 for the external entity 402 corresponding to the lesson frame 212, the lesson content 216, the mastery reward 244, or a combination thereof associated with the learning session 210. The contributor evaluation module 738 can similarly determine the external-entity assessment 406 for an educator, such as a teacher or a tutor, an educational institution, such as a school or a training department, or a combination thereof.

The contributor evaluation module 738 can determine the external-entity assessment 406 by determining the benchmark ranking. The contributor evaluation module 738 can compare multiple instances of the external entity 402 having similar instances of the lesson frame 212, the lesson content 216, the mastery reward 244, or a combination thereof as the ones used on the learning session 210. The contributor evaluation module 738 can determine the benchmark ranking based on the user's score limited or specific for the learning community 330 corresponding to the user. The contributor evaluation module 738 can use the benchmark ranking or a calculated derivative thereof as the eternal-entity assessment 406.

The assessment module 710 can pass the learner knowledge model 322, the mastery reward 244, the external-entity assessment 406, or a combination thereof to the community module 708. The community module can further determine or adjust the learning community 330 based on the learner knowledge model 322, the mastery reward 244, the external-entity assessment 406, or a combination thereof. The assessment module 710 can determine or adjust the learning community 330 based on a similarity between, a difference in, a pattern between, or a combination thereof for the learner knowledge model 322, the mastery reward 244, the external-entity assessment 406, or a combination thereof according to the community mechanism 730 as described above.

The assessment module 710 or the sub-modules therein can use the first control interface 522, the second control interface 544, the third control interface 644, or a combination thereof to access the necessary data in analyzing and processing the various data as described above. The assessment module 710 or the sub-modules therein can use the first control unit 512, the second control unit 534, the third control unit 634, or a combination thereof to compare, calculate, analyze, determine, or a combination thereof for analyzing and processing the various data as described above. The assessment module or the sub-modules therein can store the result of the analysis and the processing as described above in the first storage unit 514, the second storage unit 546, the third storage unit 646, or a combination thereof.

After analyzing the knowledge-related information, the control flow can pass from the assessment module 710 to the feedback module 712. The control flow can pass similarly as described above between the identification module 702 and the session module 704.

The feedback module 712 is configured to notify various parties regarding the information associate with the learning activity. The feedback module 712 can communicate the external-entity assessment 406 using the external feedback 404 of FIG. 4 for informing the external entity 402, the user, other remote users, other related parties, such as a parent, a teacher, a school, a school district office, an governmental organization, or a combination thereof associated with the learning session 210.

The feedback module 712 can communicate the external feedback 404 by sending, receiving, or a combination thereof for the external-entity assessment 406 using the first communication unit 516, the second communication unit 536, the third communication unit 636, or a combination thereof. The feedback module 712 can further display, audibly recreate, allow access to, or a combination thereof the external feedback 404 for the external-entity assessment 406 using the first user interface 518, the second user interface 538, the third user interface 638, or a combination thereof.

For example, the feedback module 712 can display a rating or an effectiveness for the lesson frame 212, the lesson content 216, the mastery reward 244, or a combination thereof specific to the demographic information indicated by the identification information 310, the learning style 312, the learning goal 314, the learner trait 316, for specific groupings of the learning community 330, or a combination thereof for the various parties. Also for example, the feedback module 712 can notify the parent, the user, the employer, the educator, or a combination thereof for the possible cheating scenario, the learner trait 316, the learning style 312, or a combination thereof of the user.

The feedback module 712 can further receive the external-entity input 408 of FIG. 4 from the external entity 402. For example, the feedback module 712 can receive updates or adjustments from the external entity 402. Also for example, the feedback module 712 can further receive control information, such as for adjusting or limiting the access privilege 412 of FIG. 4, from the external entity 402, such as a guardian or a teacher.

The external-entity input 408 can be in response to or in anticipation of the external feedback 404. For example, the external-entity input 408 can be in response to the possible cheating scenario or an approval for accessing a feature or content. Also for example, the external-entity input 408 can include granting of access to the content or a feature based on the subject matter 204 covered or assigned by the external entity, such as a school or a tutor.

It has been discovered that the learner knowledge model 322, the learner profile 308, the external feedback 404, or a combination thereof in conjunction with various input data and the learning community 330 can provide learning information regarding the user to responsible parties. The computing system 100 can analyze the user's learning performance across known patterns and other peers to detect possible specialties, disabilities, or a combination thereof. The computing system 100 can further communicate the possible results to responsible parties, such as a parent or a teacher. Moreover, the computing system 100 can provide the learner history 320 to professionals or specialists for further analyzing the user.

It has further been discovered that the learner knowledge model 322, the learner profile 308, the external feedback 404, or a combination thereof in conjunction with various input data and the learning community 330 can promote user-optimized learning experience. The computing system 100 can determine optimal learning modes and content organization based on determining the learner knowledge model 322, the learner profile 308, the external feedback 404, or a combination thereof in conjunction with various input data and the learning community 330. The information can be fed back to the external entity 402 for further developing and improving components optimal for various different types of users.

After determining notify the external entity 402 regarding the information associate with the learning activity the control flow can pass from the feedback module 712 to the planning module 714. The control flow can pass similarly as described above between the identification module 702 and the session module 704.

The planning module 714 is configured to notify the user of the optimal learning experience. The planning module 714 can generate various recommendations for the user, including the content recommendation 252 of FIG. 2, the frame recommendation 250 of FIG. 2, other recommendations, such as for the mastery reward 244 or the subject tutor 338, or a combination thereof.

The planning module 714 can analyze the various data to determine one or more instances of the lesson content 216, the lesson frame 212, or a combination thereof. The planning module 714 can generate the various recommendations by displaying or audibly recreating, providing access to a resource, or a combination thereof using the first control interface 522, the second control interface 544, the third control interface 644, or a combination thereof. The planning module 714 can include a frame search module 742, a content module 744, a lesson generator module 746, or a combination thereof for analyzing the various data.

The frame search module 742 is configured to select the lesson frame 212 appropriate for the user based on the learner knowledge model 322. The frame search module 742 can select the lesson frame 212 based on evaluating various instances the lesson frame 212 or the external-entity assessment 406 associated therewith. The frame search module 742 can compare the various instances against the learner knowledge model 322, the learner profile 308, the mastery level 208, the learning community 330, or a combination thereof for the user.

The frame search module 742 can narrow the instances of the lesson frame 212 based on the learner knowledge model 322, the learner profile 308, the mastery level 208, or a combination thereof. For example, the frame search module 742 can narrow the instances based on matching recommendations or requirements for the lesson frame 212, such as for age, education level, the mastery level 208, the subject matter 204, or a combination thereof for the user.

The frame search module 742 can select the lesson frame 212 having the highest instance of the external-entity assessment 406 matching the learner knowledge model 322, the learner profile 308, the mastery level 208, the learning community 330, or a combination thereof within the narrowed instances. The frame search module 742 can further select the lesson frame 212 having the highest usage or popularity among remote users within the learning community 330 or matching the learner knowledge model 322, the learner profile 308, the mastery level 208, or a combination thereof for the user.

The content module 744 is configured to select the lesson content 216 based on the learner knowledge model 322. The content module 744 select the lesson content 216 based on evaluating various instances the lesson frame 212 or the external-entity assessment 406 associated therewith. The content module 744 can select the lesson content 216 similarly as described above for the frame search module 742.

The planning module 714 can generate the frame recommendation 250 as the selected instance of the lesson frame 212. The planning module 714 can generate the content recommendation 252 as the selected instance of the lesson content 216.

The lesson generator module 746 is configured to generate the learning session 210 based on combining the lesson frame 212 and the lesson content 216. The lesson generator module 746 can generate the learning session 210 by connecting the assessment component 218 within the lesson content 216 to the content hook 214 of FIG. 2 in the lesson frame 212. The lesson generator module 746 can connect by linking addresses, inserting instructions or the assessment component 218, or a combination thereof.

For example, the lesson generator module 746 can add a specific question in the lesson content 216 into a junction point or a challenge in the lesson frame 212 having an adventure theme or a game. Also for example, the lesson generator module 746 create levels having increasing difficulties in the lesson frame 212 based on the lesson content 216.

The lesson generator module 746 can further determine the schedule recommendation 256 of FIG. 2. The lesson generator module 746 can determine the schedule recommendation 256 for the session recommendation 248 of FIG. 2 recommending the combined instance of the frame recommendation 250 and the content recommendation 252. The lesson generator module 746 can further determine the schedule recommendation for the activity recommendation 254 of FIG. 2.

The lesson generator module 746 can determine the schedule recommendation 256 using the practice method 340 of FIG. 3, including the practice schedule 342 of FIG. 3, the device target 344 of FIG. 3, or a combination thereof. The lesson generator module 746 can compare the learner knowledge model 322, the mastery level 208, the learner profile 308, or a combination thereof to the practice method 340. The lesson generator module 746 can determine the schedule recommendation 256 as the corresponding duration, the device target 344, or a combination thereof.

For example, the lesson generator module 746 can determine a start time for the next instance of the learning session 210 based on the learner knowledge model 322 or the mastery level 208 resulting from various input parameters, such as the response evaluation factor 222, the mastery reward 244, the learner profile 308, the learning community 330, or a combination thereof. Also for example, the lesson generator module 746 can similarly determine a due date for the activity recommendation 254.

The lesson generator module 746 can further determine an opportune time for the next instance of the learning session 210. The lesson generator module 746 can determine the schedule recommendation 256 to coincide the learning session 210 with or follow the learning session 210 based on an event in the learner schedule calendar 318.

The lesson generator module 746 can search the learner schedule calendar 318 based on keywords associated with the subject matter 204 for the next instance of the learning session 210. The lesson generator module 746 can further identify the event overlapping in context or associated with the subject matter 204 similar to the assessment module 710 evaluating an overlap or association in the platform-external usage 414 and the subject matter 204.

The lesson generator module 746 can adjust the schedule recommendation 256 to coincide or follow the corresponding event when the event occurs within an initially determined instance of the schedule recommendation 256. For example, the lesson generator module 746 can adjust the schedule recommendation 256 to have the learning session 210 for “French History” during or after returning from a visit to a museum having exhibits associated with France.

The planning module 714 can generate the practice recommendation 246 of FIG. 2 using the session recommendation 248, the activity recommendation 254, the schedule recommendation 256, or a combination thereof. The planning module 714 can further adjust the assessment component 218 to include the common error 240 for testing the mastery level 208 of the subject matter 204.

The planning module 714 can adjust the assessment component 218 to include the common error 240 to increase the difficulty rating 346. The planning module 714 can include the common error 240 based on the learner-specific pattern 328, the mastery level 208, the learning community 330, the learner knowledge model 322, the learning goal 314, the learner profile 308, or a combination thereof.

The planning module 714 can further notify the user of a recommendation regarding a subject tutor 338, a teacher, a program, a school, or a combination thereof. The planning module 714 can notify the user based on results of the contributor evaluation module 738.

The planning module 714 can further recommend a next instance of the mastery reward 244 for the user. The planning module 714 can recommend the mastery reward 244 based on popularity amongst the learning community 330, amongst similar instances of the identification information 310, or a combination thereof. The planning module 714 can further recommend the mastery reward 244 based on the learner profile 308, the learner-specific pattern 328, or a combination thereof. The planning module 714 can further recommend the mastery reward 244 based on the processing results of the contributor evaluation module 738 for the reward provider.

The planning module 714 can pass the next instance of the learning session 210 to the identification module 702 to be associated with the user. The identification module 702 can identify the next instance of the learning session 210 upon identifying the user.

The planning module 714 can similarly pass the activity recommendation 254 to the assessment module 710. The assessment module 710 can use the activity recommendation 254 and identification information associated therewith to recognize the platform-external usage 414 coinciding with the activity recommendation 254.

It has been discovered that the response evaluation factor 222 including factors in addition to the answer rate 230 provides increased accuracy in understanding the user's knowledge base and proficiency. The various possible factors, including the component description 226, the assessment format 228, the contextual parameter 232, the physical indication 234, the learner focus level 236, the error cause estimate 238, or a combination thereof can provide various different analysis methods and data regarding the learning activities and performance of the user. The diverse amount of input data can be used to detect and process external influences causing an aberration in the learning process, a hindrance or a helpful resource, or a combination thereof applicable for the user.

It has been discovered that the content hook 214, the lesson frame 212, and the lesson content 216 provide customizable delivery of the learning experience. The computing system 100 can use the content hook 214 to combine the lesson frame 212 and the lesson content 216 identified to be optimal components to provide the learning session 210 estimated to be most effective to the user.

It has been discovered that the learner knowledge model 322 based on various information, including the learner response 220, the response evaluation factor 222, and the learner profile 308, as described above, provides increased accuracy in understanding the user's knowledge base and proficiency. The input data, including the response evaluation factor 222, data from the learning community 330, the learner profile 308, or a combination thereof, can provide various different analysis methods and data regarding the learning activities and performance of the user. The diverse amount of input data can be used to detect and process external influences to accurately estimate the user's knowledge base and proficiency.

It has been discovered that the learner profile 308 and the learner knowledge model 322 based on the learning community 330 provide individual analysis as well as comparison across various groups sharing similarities. The computing system 100 can use the learner profile 308 and the learner knowledge model 322 to identify the learning community 330 having groupings sharing various similarities. The computing system 100 can further use the learning community 330 to further adjust the learner profile 308 and the learner knowledge model 322 as described above. The comparison across similar users provides wider base for patterns, which can be used to improve the learning experience for the user.

It has been discovered that the learner knowledge model 322, the common error 240, and the learning community 330 provide identification of common error modes and associated implications regarding the user's knowledge base. The learning community 330 allows for a wider analysis regarding the common error 240. The computing system 100 can further analyze the common error 240 to determine a likely cause. The likely cause can be used to distinguish a common mistake from a lack of knowledge or proficiency in the learner knowledge model 322.

It has been discovered that the practice recommendation 246 and the learner knowledge model 322 provide optimal reviews for the user. The practice recommendation 246 based on the learner knowledge model 322 utilizes the variety of information used in generating and adjusting the learner knowledge model 322. Thus, the practice recommendation 246 can recommend optimal practice methods and dynamically determine the timing for the practice based on variety of different information, in addition to simple score or result, and in contrast to static setting of practice timing or duration.

It has been discovered that the practice recommendation 246 and the platform-external usage 414 provide a diverse way of applying the subject matter 204 for the user. The practice recommendation 246 can provide ways for the user to utilize and practice the subject matter 204 during the user's daily life. The platform-external usage 414 can determine and verify such usage in the user's daily life.

It has been discovered that the platform-external usage 414 and the learner knowledge model 322 provide an accurate estimate of the user's knowledge base and proficiency in the subject matter 204. The platform-external usage 414 can provide information to the computing system 100 regarding the usage of the subject matter 204 during the user's daily life and external to the management platform 202. The computing system 100 can further use the platform-external usage 414 as an input data in generating and adjusting the learner knowledge model 322 without being limited to the data resulting from the management platform 202.

It has been discovered that the subject connection model 348 and the learner knowledge model 322 provide a comprehensive understanding of the user's knowledge base and proficiency. The subject connection model 348 can indicate user's understanding and proficiency in areas having logical connection or relevance to the subject matter 204. Further computing system 100 can recognize and process that a learning activity involving one instance of the subject matter 204 can indicate mastery of a different included or related instance of the subject matter 204 using the subject connection model 348 and the learner knowledge model 322.

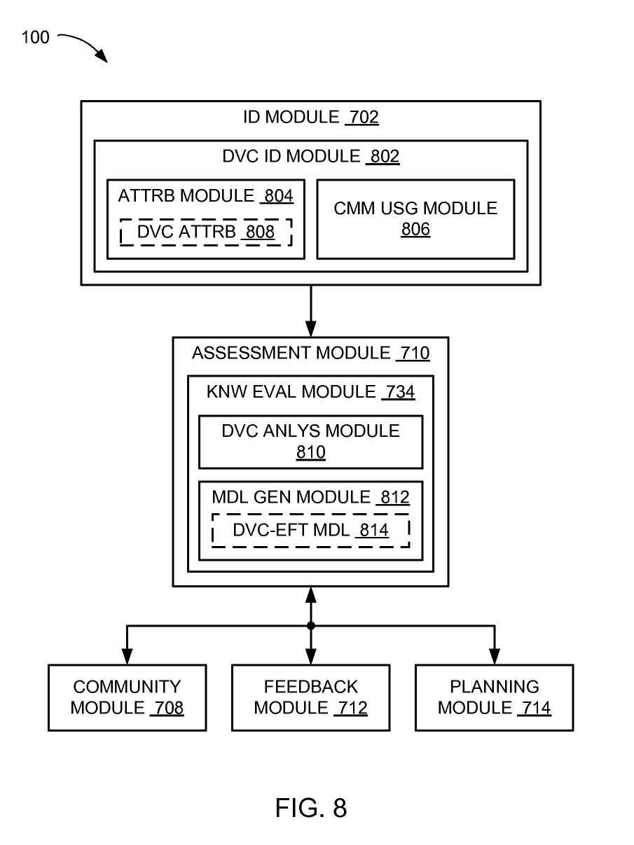

Referring now to FIG. 8, therein is shown a detailed view of the identification module 702 and the assessment module 710. The identification module 702 can include a device identification module 802.

The device identification module 802 is configured to examine usage of one or more device by the user or the remote user. The device can include an attribute module 804, a community usage module 806, or a combination thereof for examining the usage of devices.

The attribute module 804 is configured to identify one or more device owned or used by the user, the remote user, or a combination thereof. The attribute module 804 can use input from the user or the remote user, device identification corresponding to log-in information, or a combination thereof to identify the one or more device corresponding to each instance of the user or the remote user. The attribute module 804 can identify ownership or usage for the first device 102 of FIG. 1, the third device 108 of FIG. 1, or a combination thereof.

The attribute module 804 can further identify a device attribute 808 for each of the device corresponding to the user, the remote user, or a combination thereof. For example, the attribute module 804 can identify a device screen size, interaction location, brightness of the display screen, a performance rating or specification for a component in the device, other concurrent or scheduled activities on the device, network performance or activity, or a combination thereof.

The attribute module 804 can pass the device attribute 808 to the usage detection module 716 of FIG. 7. The usage detection module 716 can use the device attribute 808 to determine, identify, show, or a combination thereof for inputs from the device during the learning session 210 of FIG. 2, for platform-external usage 414 of FIG. 4, or a combination thereof.

The attribute module 804 can identify the device attribute 808 for the individual outcomes from the learning session 210 along with the response evaluation factor 222 of FIG. 2, such as a date, time, or length of time using device, total continuous time practicing, the aggregate information across all devices, the subject matter 204 of FIG. 2, the learner history 320 of FIG. 3, the learning community 330 of FIG. 3, or a combination thereof. The attribute module 804 can similarly identify the device attribute 808 for the device-usage profile 410 of FIG. 4.

The knowledge evaluation module 734 of the assessment module 710 can account for the device attribute 808 and information associated therewith. The knowledge evaluation module 734 can include a device analysis module 810, a model generator module 812, or a combination thereof.

The device analysis module 810 is configured to attribute aspects of the user's performance to the device attribute 808. The device analysis module 810 can analyze the learner response 220 of FIG. 2, the response evaluation factor 222, or a combination thereof in light of the device attribute 808.

The device analysis module 810 can determine a pattern, a cluster, a grouping, or a combination thereof in the learner history 320 based on the device attribute 808 and the learner response 220, the response evaluation factor 222, the incremental increase in the mastery level 208 of FIG. 2, or a combination thereof. The device analysis module 810 can attribute the pattern, the cluster, the grouping, or a combination thereof in the incremental increase, the learner response 220, the response evaluation factor 222, or a combination thereof to the device attribute 808 based on a threshold predetermined by the computing system 100, the external entity 402 of FIG. 4, or a combination thereof.

The model generator module 812 is configured to generate or adjust the learner knowledge model 322 of FIG. 3. The model generator module 812 can generate or adjust the learner knowledge model 322 as described above.

The model generator module 812 can generate or adjust the learner knowledge model 322 based on the device attribute 808. The model generator module 812 can combine the device attribute 808 and the pattern, the cluster, the grouping, or a combination thereof further attributed to the device attribute 808 into the learner knowledge model 322. The model generator module 812 can isolate or identify the variation of the performance that is attributed to the device features and settings using the process or the method described above.

The model generator module 812 can build a device-effect model 814 for characterizing the device's effects on the learner's performance. The model generator module 812 can combine the device-effect model 814 with corresponding information for the learning community 330. The model generator module 812 can further combine the device-effect model 814, a combined instances of the device-effect model 814 for the learning community 330, or a combination thereof to the learner knowledge model 322. The model generator module 812 can further build the device-effect model 814 concurrently with generating or adjusting the learner knowledge model 322.

The model generator module 812 can pass the resulting instance of the learner knowledge model 322, the device-effect model 814, or a combination thereof to the community module 708. The model generator module 812 can further pass the resulting instance of the learner knowledge model 322, the device-effect model 814, or a combination thereof to the feedback module 712, the planning module 714, or a combination thereof.

The computing system 100 can use the feedback module 712 to communicate the device-effect model 814, the device attribute 808, user performances attributed to the device attribute 808, or a combination thereof to the external entity 402 using the external feedback 404 of FIG. 404. The feedback module 712 can use the external feedback 404 to report out to the external entity 402 detailing the analysis findings based on various parameters.

The device-effect model 814, the device attribute 808, user performances attributed to the device attribute 808, or a combination thereof can be used to establish a benchmark across multiple devices, according to the learning style 312 of FIG. 3, according to the subject matter 204, according to the device attribute 808, based on the most used device, or a combination thereof. The external feedback 404 can be used to report out analysis results based on the content creator, benchmark across the learning community 330, by the learning style 312, top used device, the subject matter 204, by the device attribute 808, or a combination thereof.

The computing system 100 can use the planning module 714 to communicate device specific issues for the user as determined by the model generator module 812 and as highlighted in the device-effect model 814. The planning module 714 can communicate a suggestion for a change in the device or the device setting for the user based on the analysis. The planning module 714 can further change settings on the device or use of the device during the next occurrence of the learning session 210.

For example, the computing system 100 can detect a noisy environment when the learning session 210 is utilizing or will be defaulting to the microphone for input from the user. The computing system 100 can suggest switching to text or gesture input, or institute the input mode change for the next occurring instance of the learning session 210. Also for example, the computing system 100 can determine that the users in the learning community 330 surrounding the user is quiet and there are other people around, and further suggest or implement changes to use headphones to better hear the lesson and not disturb other people next to the learner.

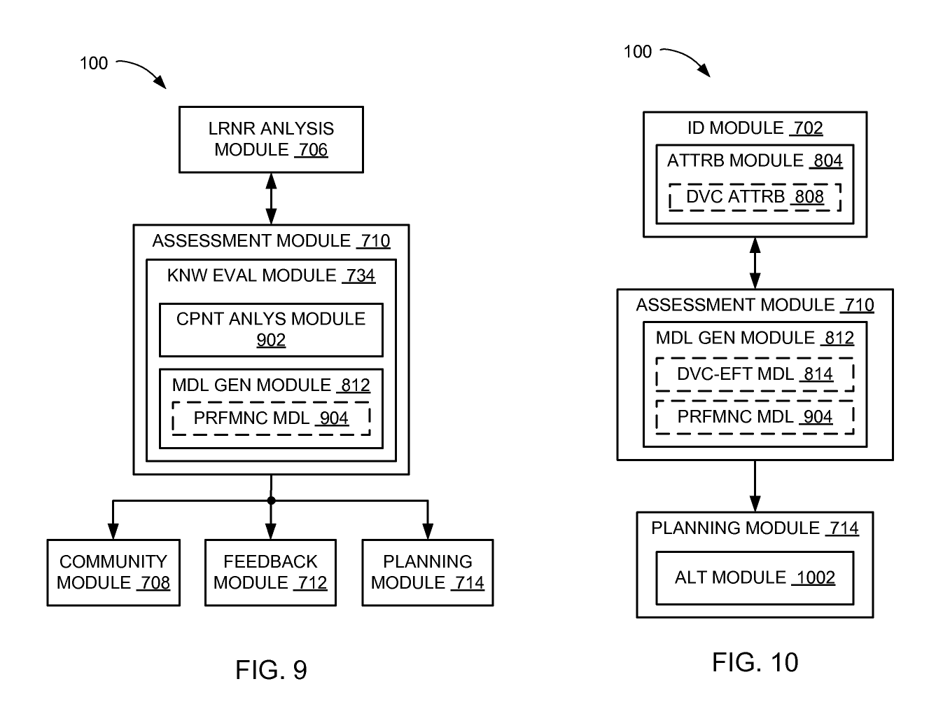

Referring now to FIG. 9, therein is shown a detailed view of the assessment module 710. The assessment module 710 can include a component analysis module 902 and the model generator module 812.

The component analysis module 902 is configured to attribute aspects of the user's performance to one or more components of the learning session 210 of FIG. 2. The component analysis module 902 can be similar to the device analysis module 810. The component analysis module 902 can analyze the learner response 220 of FIG. 2, the response evaluation factor 222 of FIG. 2, or a combination thereof in light of the lesson content 216 of FIG. 2, the lesson frame 212 of FIG. 2, or a combination thereof.

The component analysis module 902 can determine a pattern, a cluster, a grouping, or a combination thereof in the learner history 320 of FIG. 3, results of the learning session 210, or a combination thereof based on the lesson frame 212, the lesson content 216, or a combination thereof. The component analysis module 902 can determine the pattern, the cluster, the grouping, or a combination thereof across the learning community 330 of FIG. 3 for the user. The component analysis module 902 can further determine the pattern, the cluster, the grouping, or a combination thereof by further referencing the learner profile 308 of FIG. 3, the subject matter 204 of FIG. 2, or a combination thereof.

The model generator module 812 can be configured to generate or adjust the learner knowledge model 322 of FIG. 3 based on a performance model 904 for characterizing the changes in the user's knowledge or proficiency. The model generator module 812 can set the pattern, the cluster, the grouping, or a combination thereof as the learner knowledge model 322. The model generator module 812 can isolate or identify the variation of the performance that is attributed to the lesson frame 212, the lesson content 216, or a combination thereof.

The model generator module 812 can further determine the attribute from the response evaluation factor 222, the learner profile 308, or a combination thereof having the most value in predicting the performance of the user.

The assessment module 710 can pass the learner knowledge model 322, the performance model 904, or a combination thereof to the community module 708 for comparisons and processing in view of the learning community 330 or to adjust the learning community 330. The assessment module 710 can pass the learner knowledge model 322, the performance model 904, or a combination thereof to the planning module 714 to help suggest different methods of practice, different content providers, and different games to try to maximize individual performance as described above.

The assessment module 710 can further pass the learner knowledge model 322, the performance model 904, or a combination thereof to the feedback module 712 for communicating the learner knowledge model 322, the performance model 904, or a combination thereof with the external feedback 404 of FIG. 4. The assessment module 710 can produces reports that benchmark the top content providers by the subject matter 204, learner profile 308, the learner knowledge model 322, the learning community 330, or a combination thereof using the external feedback 404. The assessment module 710 can provide a breakdown of the learner performance by the device, the device attribute 808 of FIG. 8, the subject matter 204 of FIG. 2, the learner trait 316 of FIG. 3, the learning style 312 of FIG. 3, the lesson content 216, the lesson frame 212, the external entity 402 of FIG. 4, or a combination thereof.

For example, the learner analysis module 706 can determine from the user practicing math facts throughout the day that the learner performs better on the subject in the morning. That attribute of the user is passed to the assessment module 710 and combined with other learners in the learning community 330. The results can be passed back to the learner analysis module 706 to determine a “math in the morning” learning style.

Continuing with the example, the changes or improvement resulting from the change in the order of the lessons can be fed back into the computing system 100. The assessment module 710 and the learner analysis module 706 can further to suggest a “Learn Subtraction before Addition” as a new instance of the learning style 312.

Also for example, for the user studying History with content from Provider “A” and performing well with the content, the user's information can be analyzed across the learning community 330. The result of the analysis can show that Provider “A” produces the best History content for this type of learners. Similarly if the user is not performing well with Provider “A” content, the analysis result can recommend content from a different provider.

Referring now to FIG. 10, therein is shown a detailed view of the planning module 714. The planning module 714 can include an alternative module 1002. The alternative module 1002 is configured to determine an interaction selection. The alternative module 1002 can determine a change in the device setting.

The planning module 714 can determine the interaction selection in conjunction with the practice recommendation 246 of FIG. 2 including the session recommendation 248 of FIG. 2, the activity recommendation 254 of FIG. 2, the schedule recommendation 256 of FIG. 2, a recommendation for the mastery reward 244 of FIG. 2, or a combination thereof. The planning module 714 can determine the interaction selection based on a variety of factors similar to determining the practice recommendation 246 as described above.

The planning module 714 can further use the device attribute 808 from the attribute module 804, the device-effect model 814 from the model generator module 812, the performance model 904 from the model generator module 812, or a combination thereof in generating the interaction selection, the practice recommendation 246, or a combination thereof.

The planning module 714 can use the device attribute 808, the device-effect model 814, the performance model 904, or a combination thereof to suggest changes in the device setting, the lesson frame 212 of FIG. 2, the lesson content 216 of FIG. 2, the mastery reward 244, the difficulty rating 346 of FIG. 3, other parameter, or a combination thereof to improve the individual learner's performance. The planning module 714 can further use the learning community 330 of FIG. 3, the learner history 320 of FIG. 3, or a combination thereof as described above.

The planning module 714 can determine changes needed in the device or the learning activities based on a common error pattern identified with the common error 240 of FIG. 2 or the learner-specific pattern 328 of FIG. 3. The planning module 714 can identify a different style optimal for the user.

For example, the user using a tablet for a math game that has moving, falling tiles with answers thereon. The computing system 100 can determine that the errors from the user can be attributed to struggles with gesture input in the game due to the device. The planning module 714 can suggest that for a fast paced math game to use multiple-choice tiles that are in a fixed position and shoots down the falling answers as a better input method

Also for example, the lesson content 216 can include the common error 240 provided by the external entity 402. The computing system 100 can detect that one of the wrong answer for a question is picked often and suggests new content to reinforce the correct thinking about the question so the learner could understand the correct answer.

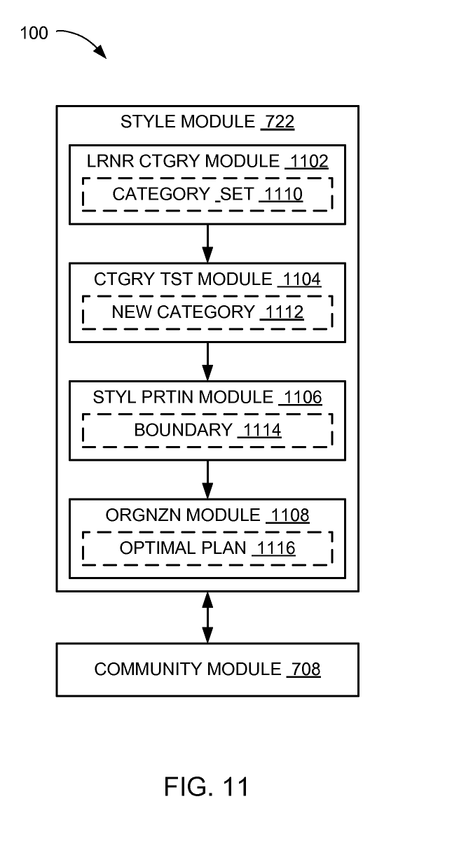

Referring now to FIG. 11, therein is shown a detailed view of the style module 722. The style module 722 can determine the learning style 312 of FIG. 3, discover categories of the learning style 312, or a combination thereof. The style module 722 can be similar to the assessment module 710 of FIG. 7 described above in determining the learning style 312. The style module 722 can include a learner category module 1102, a category testing module 1104, a style partition module 1106, an organization module 1108, or a combination thereof for determining the learning style 312.

The learner category module 1102 is configured to determine a category set 1110. The category set 1110 is a collection of possible instances for the learning style 312.

The learner category module 1102 can determine the category set 1110 based on features of the learner profile 308 of FIG. 3, the learner response 220 of FIG. 2, the response evaluation factor 222 of FIG. 2, the device attribute 808 of FIG. 8, the device-usage profile 410 of FIG. 4, global information, such as the learner history 320 of FIG. 3 or the learning community 330 of FIG. 3, or a combination thereof. The learner category module 1102 can determine the category set by identifying patterns of common styles of learning. The learner category module 1102 can continuously taking input to redefine and refine the category set 1110.

The category testing module 1104 is configured to propose a new category 1112. The new category 1112 is an instance of the learning style 312 exclusive of the category set 1110.

The category testing module 1104 can propose the new category 1112 by determining a pattern, a cluster, a grouping, a model, or a combination thereof for the user from the learner history 320 within an existing instance of the learning style 312 existing within the category set 1110. The category testing module 1104 can compare the newly detected instance of the pattern, the cluster, the grouping, the model, or a combination thereof across the learning community 330.

The category testing module 1104 can propose the new category 1112 as a sub-category matching the pattern, the cluster, the grouping, the model, or a combination thereof within the corresponding instance of the learning style 312. The category testing module 1104 can create fine grained categories of the learning style 312 using the new category 1112 for further classifying suggestions of performance improvement.

The category testing module 1104 can further propose the new category 1112 for determining a pattern, a cluster, a grouping, a model, or a combination thereof exclusive of patterns, clusters, groupings, models, or a combination thereof corresponding to the category set 1110. The category testing module 1104 can further compare the newly detected instance of the pattern, the cluster, the grouping, the model, or a combination thereof across the learning community 330.

The category testing module 1104 can propose the new category 1112 when the newly detected instance of the pattern, the cluster, the grouping, the model, or a combination thereof occurs more than a threshold amount of times in the learner history 320, across the learning community 330, or a combination thereof. The computing system 100 or the external entity 402 of FIG. 4 can predetermine or adjust the threshold amount for proposing the new category 1112.

The style partition module 1106 is configured to describe the new category 1112. The style partition module 1106 can describe the new category 1112 by setting a boundary 1114 corresponding to the new category 1112, including a threshold, a template, a range, a shape, or a combination thereof, associated with the newly detected instance of the pattern, the cluster, the grouping, the model, or a combination thereof.

The style partition module 1106 can set the boundary 1114 based on statistical analysis, a machine learning process, a pattern analysis, or a combination thereof for the newly detected instance of the pattern, the cluster, the grouping, the model, or a combination thereof within the learner history 320, across the learning community 330, or a combination thereof. For example, the style partition module 1106 can set the tolerance value or range, a cluster distance, a pattern outline, or a combination thereof for detecting or identifying the new category 1112.

The organization module 1108 is configured to determine an optimal plan 1116 corresponding to the new category 1112. The optimal plan 1116 is a characterization of the learning activity estimated to be optimal for the new category 1112.

The organization module 1108 can determine the optimal plan 1116 based on highest results from the user, the learning community 330, or a combination thereof. The organization module 1108 can set the lesson content 216 of FIG. 2, the lesson frame 212 of FIG. 2, the assessment component 218 of FIG. 2, the mastery reward 244 of FIG. 2, a categorization thereof, or a combination thereof associated with the highest results from the user, the learning community 330, or a combination thereof as the optimal plan 1116.

The style module 722 can combine the new category 1112, the boundary 1114, and the optimal plan 1116 as a new instance of the learning style 312. The style module 722 can update the category set 1110 by adding the new instance of the learning style 312 to the category set 1110.

The computing system 100 can share the new instance of the learning style 312 with the learning community 330. The computing system 100 can further use the updated instance of the learning style 312 to further process and identify optimal choices for content, subject, game style, rewards, practice style, content creators, game creators, practice creator, reward creators, or a combination thereof for the user.

For example, the style module 722 can use the performance data, device data, provider data, or a combination thereof, and determine the new instance of the learning style 312 for a subset of the learning population for whom reading the information out loud results in better retention of the lesson for learners that struggle with reading text. The new instance of the learning style 312 can be verified by changing other variables of the lesson such as varying the size, font, and color of the text and seeing that the performance improvement is optimal with read-out-loud type of the optimal plan 1116.

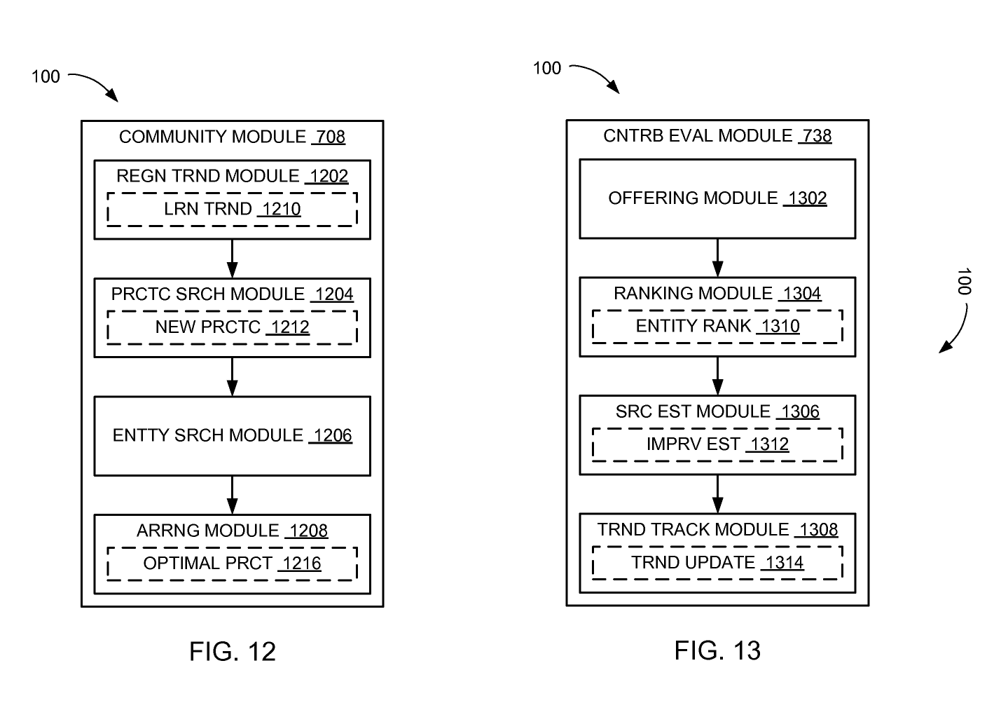

Referring now to FIG. 12, therein is shown a detailed view of the community module 708. The community module 708 can aggregates the raw input and the output of other modules to produce a community wide analysis of learner performance. The community module 708 can produce the community wide analysis as described above. The community module 708 can further include a regional trend module 1202, a practice search module 1204, an entity search module 1206, an arrangement module 1208, or a combination thereof for producing the community wide analysis of learner performance.

The regional trend module 1202 is configured to identify trends and changes over a grouping of users. The regional trend module 1202 can identify trends and changes for various geographical areas. For example, the regional trend module 1202 can group the users based on a neighborhood, a school district, a city, a state, a country, or a combination thereof.

The regional trend module 1202 can perform a machine-learning analysis or a pattern analysis to detect faster or above average growth in the incremental increase in the mastery level 208 of FIG. 2 of users within the geographical area in comparison to that of other geographical areas. The regional trend module 1202 can further identify a shared similarity in various data amongst the users within the geographical area having the faster or above average growth.

For example, the regional trend module 1202 can identify the response evaluation factor 222 of FIG. 2, the learning session 210 of FIG. 2, the learner profile 308 of FIG. 3, the external entity 402 of FIG. 4, an aspect therein, or a combination thereof shared by the users within the geographical area. Also for example, the regional trend module 1202 can search the internet or available databases for keywords associated with education, such as a new educational program or a new requirement, and keywords associated with the geographic area for a contributing factor.

The regional trend module 1202 can set the shared similarity, the contributing factor, or a combination thereof as a learning trend 1210. The learning trend 1210 can represent an emerging best practice or best suggestion for schools and school systems. The computing system 100 can use the learning trend 1210 to report current issues, trends, and practices in learning based on many attributes, such as the learning style 312 of FIG. 3, geography, schools, school systems, states, countries, or a combination thereof.

The practice search module 1204 is configured to identify a new practice 1212 associated with the learning trend 1210. The new practice 1212 is a learning activity associated with the learning trend 1210. The new practice 1212 can include an instance of the lesson frame 212 of FIG. 2, the lesson content 216 of FIG. 2, the mastery reward 244 of FIG. 2, the activity recommendation 254 of FIG. 2, or a combination thereof associated with the learning trend 1210. The practice search module 1204 can determine the association based on matching or analyzing keywords in descriptions or reviews for the learning activity.

The computing system 100 can use the new practice 1212 to further validate the results regarding increase in the mastery level 208 for the user, the learning community 330 of FIG. 3, the geographic area, or a combination thereof. It has been determined that the new practice 1212 and the learning community 330 can provide a larger testing in community to validate the results. It has also been determined that the learning trend 1210 can create a group of best practices based on fine grained learning styles.

The entity search module 1206 is configured to analyze the external entity 402 of FIG. 4. The entity search module 1206 can benchmark individual instances of the external entity 402 against instances, including schools, school systems, cities, counties, states, or a combination thereof. The entity search module 1206 can further benchmark individual instances of the external entity 402 against other similar content, other reward providers or assessment providers, or a combination thereof. The entity search module 1206 can group the benchmarks rankings by learner attributes, subject, assessment type, or a combination thereof. The entity search module 1206 can use results of the analysis comparing various instances of the geographical area performed in the regional trend module 1202.

The arrangement module 1208 is configured to generate an optimal practice 1216. The optimal practice 1216 can be a new instance of the learning activity optimal for the user. The arrangement module 1208 can generate the optimal practice 1216 by cross-referencing the new practice 1212 or data associated therewith with the learner profile 308.

For example, the arrangement module 1208 can perform a sub-analysis for the learning results of the learning trend for users within the geographic area and matching the learner profile 308. Also for example, the arrangement module 1208 can check the results of the larger testing of the new practice 1212 across the learning community 330 against a threshold for validation predetermined by the computing system 100 or the external entity 402.

The arrangement module 1208 can set the new practice 1212 corresponding to the user, validated across the learning community 330, or a combination thereof as the optimal practice 1216. The computing system 100 can communicate or suggest the optimal practice 1216 to the user, the external entity 402 associated with the user's activities, or a combination thereof.

For example, a fifth grade in one school system could be the highest performance on English vocabulary. The classroom attributes match another similar grade in another school at a different geographical location. The computing system 100 can use the communication or suggestion to share the best content, best gaming interaction, best rewards motivating the high performance. Also for example, a similar analysis can be performed for any finer grained grouping, such as for a group of common 12 year old boys aggregated from around the world with the same attributes and combined into a community to suggest the best practice of learning for those boys.

Referring now to FIG. 13, therein is shown a detailed view of the contributor evaluation module 738. The contributor evaluation module 738 can generate results for informing and suggesting improvements to the external entity 402 of FIG. 4 providing the learning materials and practices used in the management platform 202 of FIG. 2. The contributor evaluation module 738 can generate the results as described above. The contributor evaluation module 738 can further include an offering module 1302, a ranking module 1304, a source estimation module 1306, a trend tracker module 1308, or a combination thereof for generating the results.

The offering module 1302 is configured to analyze products or services offered by one or more instances of the external entity 402. The offering module 1302 can use uses all of the previous raw inputs and output of all of the modules along with performance data associated with the learning community 330 of FIG. 3 for the analysis.

The offering module 1302 can filter or statistically analyze the products or services using the results of the learning activity based on various input data, such as the learner profile 308 of FIG. 3, the learner history 320 of FIG. 3, the response evaluation factor 222 of FIG. 2, an aspect therein, or a combination thereof. The offering module 1302 can further use a machine-learning analysis, a pattern analysis, or a combination thereof and compare the available data against all available instances of the learning style 312 of FIG. 3 and provider for the management platform 202.

The ranking module 1304 is configured to determine a position for the external entity 402 based the analysis result of the offering module 1302. The ranking module can assign an entity rank 1310 for the external entity 402 based on the analysis result. The ranking module 1304 can create benchmarks against all instances of the learning style 312 and provider available for the management platform 202. The external-entity assessment 406 of FIG. 4 can include the entity rank 1310.

The ranking module 1304 can determine the entity rank 1310 based on categories or groupings of the available data. For example, the entity rank 1310 can correspond to a grouping in the learning community 330. Also for example, the entity rank 1310 can correspond to the learner profile 308, the mastery level 208 of FIG. 2, the subject matter 204 of FIG. 2, the learner knowledge model 322 of FIG. 3, or a combination thereof.

The source estimation module 1306 is configured to determine an improvement estimate 1312 for the external entity 402. The improvement estimate 1312 is a determination of a likely motivation causing the differences in the analysis. The improvement estimate 1312 can provide an estimate for the motivation behind the high performance for the top instance of the entity rank 1310.

The source estimation module 1306 can use the user rating, the external-entity assessment 406, product or service description, advertisement material, specification, or a combination thereof to identify the various features, mechanisms, or aspects for each product or service. The source estimation module 1306 can determine the improvement estimate 1312 using the various features, mechanisms, or aspects in a variety of ways.

For example, the source estimation module 1306 can determine the improvement estimate 1312 by identifying a unique factor in the top instance of the entity rank 1310. Also for example, the source estimation module 1306 can determine a similarity shared amongst top multiple instances of the entity rank 1310 but missing in a bottom multiple instances of the entity rank 1310.

The trend tracker module 1308 is configured to repeat the process described above for the contributor evaluation module 738 and determine a trend update 1314. The trend update 1314 is a change in the improvement estimate 1312. The trend tracker module 1308 can track user ratings, user performance, performance associated with the learning community 330, or a combination thereof. The trend tracker module 1308 can assign the difference in the improvement estimate 1312, the external entity 402 showing improvement over a set period of time, or a combination thereof as the trend update 1314.

The computing system 100 can use the entity rank 1310, the improvement estimate 1312, the trend update 1314, or a combination thereof to notify and recommend information to the user, the external entity 402, or a combination thereof. The computing system 100 can use the various recommendations and feedback to notify the corresponding parties. The computing system 100 can use the results of the contributor evaluation module 738 to report rankings to providers or leaders in categories.

The computing system 100 can further report based on various categories or groupings of information, as described above. The computing system 100 can further communicate the improvement estimate 1312 for other instances of the external entity 402 for improving the effectiveness of their supplied content the effectiveness of their supplied content. The computing system 100 can further use the results of the contributor evaluation module 738 to reports provider ecosystem trends and ranking across all providers.

For example, one reward provider could see that it motivates 15 year old girls to study more math than other rewards. Another provider can use a different practice method, such as studying every other day in the afternoon, which can be determined to provide the best performance on art history facts.

For illustrative purposes, the various modules have been described as being specific to the first device 102, the second device 106 of FIG. 1, or the third device 108 of FIG. 1. However, it is understood that the modules can be distributed differently. For example, the various modules can be implemented in a different device, or the functionalities of the modules can be distributed across multiple devices. Also as an example, the various modules can be stored in a non-transitory memory medium.

For a more specific example, the functions of the learner analysis module 706 of FIG. 7 can be merged and be specific to the first device 102, the second device 106, or the third device 108. Also for a more specific example, the function for determining the learner profile 308 of FIG. 3 can be separated into different modules, separated across the first device 102, the second device 106, and the third device 108, or a combination thereof. As a further specific example, one or more modules show in FIG. 7 can be stored in the non-transitory memory medium for distribution to a different system, a different device, a different user, or a combination thereof.

The modules described in this application can be stored in the non-transitory computer readable medium. The first storage unit 514 of FIG. 5, the second storage unit 546 of FIG. 5, the third storage unit 646 of FIG. 6, or a combination thereof can represent the non-transitory computer readable medium. The first storage unit 514, the second storage unit 446, the third storage unit 646, or a combination thereof or a portion thereof can be removable from the first device 102, the second device 106, or the third device 108. Examples of the non-transitory computer readable medium can be a non-volatile memory card or stick, an external hard disk drive, a tape cassette, or an optical disk.

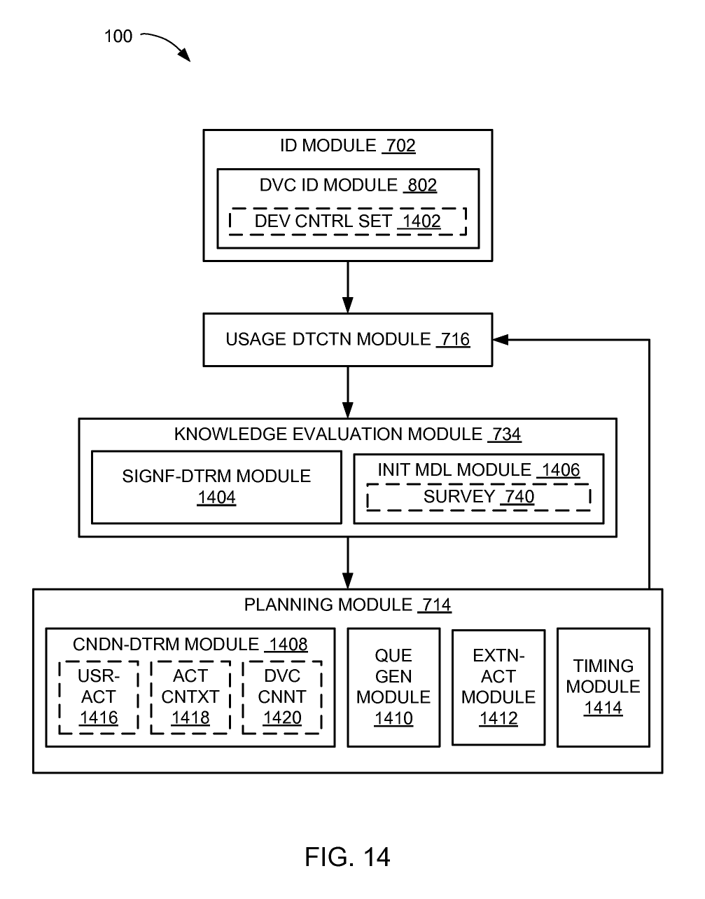

Referring now to FIG. 14, therein is shown a detailed view of the knowledge evaluation module 734 and the planning module 714. The knowledge evaluation module 734 and the planning module 714 can be coupled to the identification module 702 and the usage detection module 716.

The identification module 702 can include the device identification module 802. The device identification module 802 can be configured to identify a device control set 1402. The device control set 1402 is a record of one or more device owned by or accessible to the user. The device control set 1402 can include the first device 102 of FIG. 1, the second device 106 of FIG. 1, the third device 108 of FIG. 1, or a combination thereof. The device control set 1402 can be represented by an identification, such as a serial number or a name, a manufacturer information, a type or a category, a time or a location associated with the access, or a combination thereof for the device.

The identification module 702 can identify the device control set 1402 based on registration information for the device. The identification module 702 can identify the device control set 1402 from the learner history 320 of FIG. 3, the device-usage profile 410 of FIG. 4, or a combination thereof.

For example, the identification module 702 can identify the device control set 1402 based on device registration or ownership information provided by the user, the user's employer, the school, a device retailer or manufacturer, or a combination thereof. Also for example, the identification module 702 can identify the device control set 1402 based on searching the learner history 320, the device-usage profile 410, or a combination thereof for the device accessed by the user for performing the associated function.

The usage detection module 716 can be configured to determine the platform-external usage 414 of FIG. 4 as described above. The usage detection module 716 can determine the platform-external usage 414 for one or more devices corresponding to the device control set 1402 for each user. The usage detection module 716 can determine the platform-external usage 414 for the first device 102, the second device 106, the third device 108, or a combination thereof for one instance of the user.

The usage detection module 716 can compile the usage information for each device according to the user associated with the usage information. The usage detection module 716 can combine usage information across multiple devices described in the device control set 1402 to determine the device-usage profile 410 for each user.

The knowledge evaluation module 734 can be configured to generate the learner knowledge model 322 of FIG. 3 including the mastery level 208 of FIG. 2 based on the platform-external usage 414. The knowledge evaluation module 734 can generate the learner knowledge model 322 by calculating the mastery level 208 for the subject matter 204 of FIG. 2 based on the platform-external usage 414 as described above. For example, the knowledge evaluation module 734 can determine the overlap and the accuracy between the platform-external usage 414 and the subject matter 204, and calculate the incremental adjustment to the mastery level 208 based on the result of the determination.

The knowledge evaluation module 734 can include a significance-determination module 1404, an initial modeling module 1406, or a combination thereof for generating or adjusting the learner knowledge model 322. The significance-determination module 1404 is configured to determine the usage significance 418 of FIG. 4 for the platform-external usage 414 as described above.

The significance-determination module 1404 can determine the usage significance 418 based on a source providing the platform-external usage 414 as perceived by the usage detection module 716. For example, the significance-determination module 1404 can determine the source as the user or a source external to the user, such as a website or a different person near the user.

The significance-determination module 1404 can determine a value for the usage significance 418 as indicating higher level for the mastery level 208 when the user provides the platform-external usage 414, such as by speaking or emulating the subject matter 204. The significance-determination module 1404 can determine the value for the usage significance 418 as indicating lower level of increase for the mastery level 208 when the user encounters the platform-external usage 414, such as by hearing or seeing the subject matter 204.

The significance-determination module 1404 can further determine a value for the usage significance 418 for lowering the mastery level 208. The significance-determination module 1404 can assign the value for lowering the mastery level 208 when the knowledge evaluation module 734 determine the platform-external usage 414 as an incorrect usage or application of the subject matter 204, as described above. The significance-determination module 1404 can further assign the value for lowering the mastery level 208 based on a pattern or a frequency of the incorrect usage or application.

The significance-determination module 1404 can determine the value for the usage significance 418 based on a number or a frequency the platform-external usage 414 associated with the same instance of the subject matter 204. The significance-determination module 1404 can further determine the value for the usage significance 418 based on contextual information associated with the platform-external usage 414.

For example, the significance-determination module 1404 can determine the value for the usage significance 418 based on the location, the time, the people or the devices surrounding the user, or a combination thereof associated with the platform-external usage 414 having the contextual overlap 416 of FIG. 4 with the subject matter 204. Also for example, the significance-determination module 1404 can determine the value for the usage significance 418 based on the abstract importance, the purpose, the meaning, or a combination thereof implicated by the contextual information, in comparison to the learning goal 314 of FIG. 3, or a combination thereof.

As a more specific example, the significance-determination module 1404 can decrease the incremental improvement in the mastery level 208 when the platform-external usage 414 is associated with the learning goal 314, such as taking a standardized test or a scheduled performance as a goal or purpose of one or more learning activities. As a further specific example, the significance-determination module 1404 can increase the incremental improvement in the mastery level 208 when the platform-external usage 414 is not associated with the learning goal 314, such as use in daily activity or routine.

The significance-determination module 1404 can determine the usage significance 418 for evaluating the platform-external usage 414 based on the subject matter 204. The computing system 100 can generate or adjust the learner knowledge model 322 or the mastery level 208 thereof based on the usage significance 418 as described above.

The significance-determination module 1404 can use the first control interface 522 of FIG. 5, the second control interface 544 of FIG. 5, the third control interface 644 of FIG. 6, the first storage interface 524 of FIG. 5, the second storage interface 548 of FIG. 5, the third storage interface 648, or a combination thereof to access the device-usage profile 410 or the platform-external usage 414. The significance-determination module 1404 can further use the first control unit 512 of FIG. 5, the second control unit 534 of FIG. 5, the third control unit 634 of FIG. 6, or a combination thereof to determine the value for the usage significance 418.

The initial modeling module 1406 is configured to identify the starting point 324 of FIG. 3. The initial modeling module 1406 can identify the starting point 324 using a survey 740. The survey 740 is a diagnostic interaction designed to assess the user. The survey 740 can include directed information for identifying learner traits or characteristics, such as specific prompts associated with or through a survey, including the identification information 310 of FIG. 3, the learning style 312 of FIG. 3, the learning goal 314, the learner trait 316 of FIG. 3, or a combination thereof.

The survey 740 can be for assessing the learner profile 308, including the learning style 312 or the learner trait 316. The survey 740 can be for assessing the learner knowledge model 322, including the mastery level 208 corresponding to one or more instances of the subject matter 204. The survey 740 can include a set of questions, exercises, tasks, or a combination thereof for interacting with the user. For example, the survey 740 can include a personality test, an exercise for discovering the learning style 312, a hearing test, a placement test, information gathering questionnaire, a writing task, or a combination thereof.

The initial modeling module 1406 can identify the starting point 324 without the survey 740. The initial modeling module 1406 can identify the starting point 324 using a variety of processes. For example, the initial modeling module 1406 can determine the starting point 324 based on instances of the learner knowledge model 322 for the learning community 330 of FIG. 3. The initial modeling module 1406 can determine the starting point 324 as a collection of instances for the subject matter 204, the mastery level 208 associated therewith, or a combination thereof across the learning community 330.

As a more specific example, the initial modeling module 1406 can identify the starting point 324 of the user as including the subject matter 204 occurring in the learner knowledge model 322 of the remote users. The initial modeling module 1406 can analyze the remote users sharing a similarity with the user as indicated in the learning community 330. Also as a more specific example, the initial modeling module 1406 can identify the starting point 324 by assigning the mastery level 208 a mean or a median value for the subject matter 204 within the learning community 330.

Also for example, the initial modeling module 1406 can based on first instance of the learning session 210 of FIG. 2. The initial modeling module 1406 can identify the starting point 324 to include the subject matter 204 when the user first encounters the subject matter 204. The initial modeling module 1406 can assign the mastery level 208 based on the user's performance during the first encounter. The initial modeling module 1406 can adjust the starting point 324 to include a new instance of the subject matter 204 when the user encounters the new instance of the subject matter 204.

For further example, the initial modeling module 1406 can use the subject connection model 348 of FIG. 3. The initial modeling module 1406 can include one or more instance of the subject matter 204 associated with the new instance of the subject matter 204 according to the subject connection model 348. The initial modeling module 1406 can include the one or more instance in the starting point 324. The initial modeling module 1406 can further calculate the mastery level 208 for the associated instances of the subject matter 204 based on the subject connection model 348.

As a specific example, the initial modeling module 1406 can include “French History” or “French Language” into the starting point 324 when the user learns “French Cooking” according to the subject connection model 348. As a further specific example, the initial modeling module 1406 can calculate the mastery level 208 associated with “French History” or “French Language” based on the content of the encounter, such as overlap in keywords or distance between clusters, based on an equation or a process, or a combination thereof described by the subject connection model 348.

The initial modeling module 1406 can use the first control unit 512, the second control unit 534, the third control unit 634, or a combination thereof to determine the starting point 324. The initial modeling module 1406 can further use the first user interface 518 of FIG. 5, the second user interface 538 of FIG. 5, the third user interface 638 of FIG. 6, or a combination thereof to implement the survey 740.

The planning module 714 can be configured to integrate and evaluate the learning activity in user's activities external to the management platform 202 of FIG. 2. The planning module 714 can further include a condition-determination module 1408, a question generator module 1410, an external-activity module 1412, a timing module 1414, or a combination thereof for the integrated learning activities.

The condition-determination module 1408 is configured to identify user activities external to the management platform 202 and associated with the subject matter 204. The condition-determination module 1408 can identify ongoing or previously occurring user activities external to the management platform 202 based on the platform-external usage 414. The condition-determination module 1408 can further identify user activities scheduled to occur at a future time, after a current time, external to the management platform 202 and associated with the subject matter 204.

The user-activity 1416 can determine a user-activity 1416, an activity-context 1418, a device-connection 1420, or a combination thereof. The activity-context 1418, the device-connection 1420, or a combination thereof can be associated with the user-activity 1416.

The user-activity 1416 is an action associated with the user occurring external to the management platform 202 or the learning session 210. The user-activity 1416 can include the user-activity 1416 scheduled or likely to occur at the future time. The user-activity 1416 can include activities scheduled on the learner schedule calendar 318 of FIG. 3, activities likely to occur at a later time based on the current activity or the current context, or a combination thereof.

The activity-context 1418 is a contextual description of the user-activity 1416. The activity-context 1418 can be a location, a time, a duration, a meaning or a significance to the user, a connection to the user or another activity of the user, or a combination thereof associated with the user-activity 1416.

The device-connection 1420 is a description of an association between a device of the computing system 100 and the user-activity 1416. The device-connection 1420 can identify the device, such as the first device 102 or the third device 108, scheduled or likely to be used for the user-activity 1416. The device-connection 1420 can include the identity of the device from the device control set 1402.

The condition-determination module 1408 can further determine the user-activity 1416. The condition-determination module 1408 can determine the user-activity 1416 scheduled or likely to occur at the later time. The condition-determination module 1408 can determine the user-activity 1416 in a variety of ways.

For example, the condition-determination module 1408 can determine the user-activity 1416 by searching the learner schedule calendar 318. Also for example, the condition-determination module 1408 can determine the user-activity 1416 based on the current event, the current context, or a combination thereof in comparison to a previous pattern or a template pattern having similar event or similar context as the current event, the current context, or a combination thereof.

As a more specific example, the condition-determination module 1408 can determine the user-activity 1416 based on a repeated pattern of the user, such watching a specific program at a specific time of the day or device charging behavior. Also as a more specific example, the condition-determination module 1408 can determine the user-activity 1416 based on the template pattern predetermined by the computing system 100, such as for describing meal times or displaying a notice based on approaching event on the learner schedule calendar 318.

The condition-determination module 1408 can similarly determine the activity-context 1418, the device-connection 1420, or a combination thereof. For example, the condition-determination module 1408 can determine the activity-context 1418, the device-connection 1420, or a combination thereof by searching the user's data, including the learner schedule calendar 318, user's correspondence, such as email or chat history, user's notes, or a combination thereof for contextual keywords associated with the user-activity 1416. Also for example, the condition-determination module 1408 can determine the activity-context 1418, the device-connection 1420, or a combination thereof based on the previous pattern or the template pattern.

The computing system 100 can use the user-activity 1416, the activity-context 1418, the device-connection 1420, or a combination thereof to practice the subject matter 204. Details regarding the use of the user-activity 1416, the activity-context 1418, the device-connection 1420, or a combination thereof will be described below.

The question generator module 1410 is configured to integrate the user's experience with the learning activity. The question generator module 1410 can generate the assessment component 218 based on the platform-external usage 414.

The question generator module 1410 can generate the assessment component 218 based on the platform-external usage 414 using the contextual overlap 416 with the subject matter 204. The question generator module 1410 can search the device-usage profile 410, the learner schedule calendar 318, or a combination for the platform-external usage 414 having the contextual overlap 416 with the subject matter 204 of the learning session 210.

The question generator module 1410 can identify relevant information of the platform-external usage 414, such as keywords or key image associated with the contextual overlap 416 and the platform-external usage 414, a time or a location of the platform-external usage 414, the device associated with the platform-external usage 414, the context surrounding the platform-external usage 414, or a combination thereof. The question generator module 1410 can generate the assessment component 218 by including the relevant information to corresponding question or activity for communication to the user.

For example, the question generator module 1410 can include a phrase, such as “when you visited . . . ” or “according to . . . ”, referring to the platform-external usage 414, the relevant information, or a combination thereof, display a picture associated with the platform-external usage 414, or a combination thereof during the learning session 210 for the assessment component 218. Also for example, the question generator module 1410 can select the content of the question, select the theme, or a combination thereof corresponding to the platform-external usage 414.

The question generator module 1410 can further generate the assessment component 218 by receiving content information associated with the platform-external usage 414, the relevant information thereof, or a combination thereof from the external entity 402 of FIG. 4 associated with the platform-external usage 414, the relevant information thereof, or a combination thereof. For example, the question generator module 1410 can receive questions, answers, themes, exercises or a combination thereof from the external entity 402, a museum or a zoo, based on the user's visit thereto. The question generator module 1410 can generate the assessment component 218 by interacting with the user using the received content during the learning session 210 for the subject matter 204 having the contextual overlap 416 with the platform-external usage 414.

It has been discovered that the assessment component 218 generated based on the platform-external usage 414 provide contextual relevancy of the subject matter 204 for the user. The assessment component 218 generated based on the platform-external usage 414 can use the user's personal experiences in teaching or practicing the subject matter 204. The personal connection and the relevancy can further provide effective learning and faster increase in the subject matter 204.

In generating the assessment component 218, the question generator module 1410 can use the first communication unit 516 of FIG. 5, the second communication unit 536 of FIG. 5, the third communication unit 636 of FIG. 6, or a combination thereof to receive the content. The question generator module 1410 can further use the first user interface 518, the second user interface 538, the third user interface 638, or a combination thereof to display the assessment component 218. The question generator module 1410 can also use the first control unit 512, the second control unit 534, the third control unit 634, or a combination thereof to process the information.

The external-activity module 1412 is configured to facilitate the learning activity external to the learning session 210 or the management platform 202. The external-activity module 1412 can generate the activity recommendation 254 of FIG. 2 for reinforcing the subject matter 204 without a learning session 210.

The external-activity module 1412 can generate the activity recommendation 254 in a variety of ways. For example, the external-activity module 1412 can generate the activity recommendation 254 by using the first communication unit 516, the second communication unit 536, the third communication unit 636, or a combination thereof to receive activities, projects, exercises, or a combination thereof from the external entity 402. The external-activity module 1412 can generate the activity recommendation 254 by communicating a description of the activities, projects, exercises, or a combination thereof from the received information. The external-activity module 1412 can further evaluate the platform-external usage 414 to determine completion of the activities, projects, exercises, or a combination thereof.

Also for example, the external-activity module 1412 can generate the activity recommendation 254 by selecting a task or an action associated with the subject matter 204 with the first control unit 512, the second control unit 534, the third control unit 634, or a combination thereof and communicating a description of the task or the action. As a more specific example, the external-activity module 1412 can include repetition or application as a task or an action associated with instances of the subject matter 204 requiring memorization. The external-activity module 1412 can combine the repetition or the application with the subject matter 204 applicable to the user and communicate the combined information for the task or the action to the user.

The external-activity module 1412 can further generate the assessment component 218 external to the learning session 210. The external-activity module 1412 can generate the assessment component 218 external to the learning session 210 for practicing the subject matter 204. The external-activity module 1412 can generate the user-activity 1416 by selecting one or more instance of the assessment component 218 corresponding to the subject matter 204 or the learning session 210 encountered by the user. The external-activity module 1412 can select the assessment component 218 from the learner history 320.

The external-activity module 1412 can generate the assessment component 218 external to the learning session 210 based on the device control set 1402. The external-activity module 1412 can generate the assessment component 218 by interacting with the user according to the assessment component 218 using one or more devices listed in the device control set 1402. The external-activity module 1412 can further generate the assessment component 218 using the device currently receiving user input or located near the user, as determined based on the results of the usage detection module 716, based on the user-activity 1416, or a combination thereof.

The external-activity module 1412 can generate the assessment component 218 external to the learning session 210 without prior indication to the user. The external-activity module 1412 can implement a surprise reminder or review, a pop-quiz, a review exercise, or a combination thereof unanticipated by the user by generating assessment component 218 external to the learning session 210. For example, the condition-determination module 1408 can communicate a question or information previously encountered by the user on a device currently being used by the user, exclusive of the management platform 202 or the learning session 210, such as on a stove or a refrigerator during cooking or on the television during a commercial break.

It has been discovered that the assessment component 218 generated with the user-activity 1416 and the device-connection 1420 provides seamless reinforcement of the subject matter 204 during the user's normal routine. The computing system 100 can communicate information or questions for practicing the subject matter 204 using devices near or in-use by the user, during opportune times in the user's daily routine.

The timing module 1414 is configured to schedule the learning activity. The timing module 1414 can schedule the learning activity for integrating the learning activity with user's schedule or experiences. The timing module 1414 can temporally schedule the learning activity by determining a start time or a due date for the learning session 210, the activity recommendation 254, or a combination thereof.

The timing module 1414 can schedule the learning session 210 based on the user-activity 1416 with the activity-context 1418 thereof associated with the subject matter 204 for the learning session 210. The timing module 1414 can schedule the learning session 210 to occur temporally near or during the user-activity 1416 having the activity-context 1418 overlapping the subject matter 204 for the learning session 210. The timing module 1414 can determine the overlap using processes similar to determining the contextual overlap 416 for the platform-external usage 414.

The timing module 1414 can further schedule based on comparing the activity-context 1418, characteristics of the learning session 210, the learner knowledge model 322, or a combination thereof. For example, the timing module 1414 can schedule to the learning session 210 to occur during the user-activity 1416 when the learning session 210 is not intrusive, such as audibly reciting information with use of headphones or only uses display for interacting with the user, not time-sensitive, or a combination thereof.

Also for example, the timing module 1414 can schedule the learning session 210 to occur within a duration before or after the user-activity 1416 when the mastery level 208 of the user for the subject matter 204 is lower than the average participant of the user-activity 1416. For further example, the timing module 1414 can schedule the learning session 210 to occur within a duration before or after the user-activity 1416 when the user-activity 1416 requires user interaction, such as verbal interaction or physical participation, or a combination thereof. The timing module 1414 can schedule the duration based on processes, methods, templates, thresholds, or a combination thereof predetermined by the computing system 100.

It has been discovered that the learning session 210 scheduled based on the user-activity 1416 provides contextually relevant learning for the user. The learning session 210 occurring temporally based on the user-activity 1416 and having similarity thereto can reinforce the subject matter 204 and provide diverse learning experience for the user.

The timing module 1414 can similarly schedule the learning session 210 based on the platform-external usage 414 with the platform-external usage 414 associated with the subject matter 204 for the learning session 210. The timing module 1414 can adjust the schedule recommendation 256 of FIG. 2 for the learning session 210 based on determining the platform-external usage 414 associated with the subject matter 204 for the learning session 210.

The timing module 1414 can adjust the schedule recommendation 256 when the computing system 100 determines unscheduled and relevant usage of the devices by the user. For example, the timing module 1414 can schedule a review of the subject matter 204 based on unanticipated application of the subject matter 204 in user's daily routine. Also for example, the timing module 1414 can schedule a test or an exercise of the subject matter 204 based on accuracy or the usage significance 418 of FIG. 4 for the platform-external usage 414.

It has been discovered that the learning session 210 scheduled based on the platform-external usage 414 provides contextually relevant learning for the user. The learning session 210 occurring temporally based on the platform-external usage 414 and having similarity thereto can reinforce the subject matter 204 and provide diverse learning experience for the user.

The timing module 1414 can further adjust the practice method 340 of FIG. 3 based on the platform-external usage 414. The timing module 1414 can adjust the practice method 340 in a variety of ways. For example, the timing module 1414 can adjust the practice method 340 by highlighting a specific method, activity, assessment instrument, timing, or a specific combination thereof based on a frequency or a lack of occurrence of the platform-external usage 414 having similarity to the specific instance of the practice method 340.

Also for example, the timing module 1414 can adjust the practice method 340 based on the accuracy in the platform-external usage 414 for the usage or the application of the subject matter 204. For further example, the timing module 1414 can adjust the practice method 340 by adjusting the difficulty rating 346 of FIG. 3 or the practice schedule 342 of FIG. 3 based on the usage significance 418 of the platform-external usage 414.

It has been discovered that the learner knowledge model 322 provide based on the platform-external usage 414 provides an accurate estimate of the user's knowledge base and proficiency in the subject matter 204. The platform-external usage 414 can provide information to the computing system 100 regarding the usage of the subject matter 204 during the user's daily life and external to the management platform 202. The computing system 100 can further use the platform-external usage 414 as an input data in generating and adjusting the learner knowledge model 322 without being limited to the data resulting from the learning session 210.

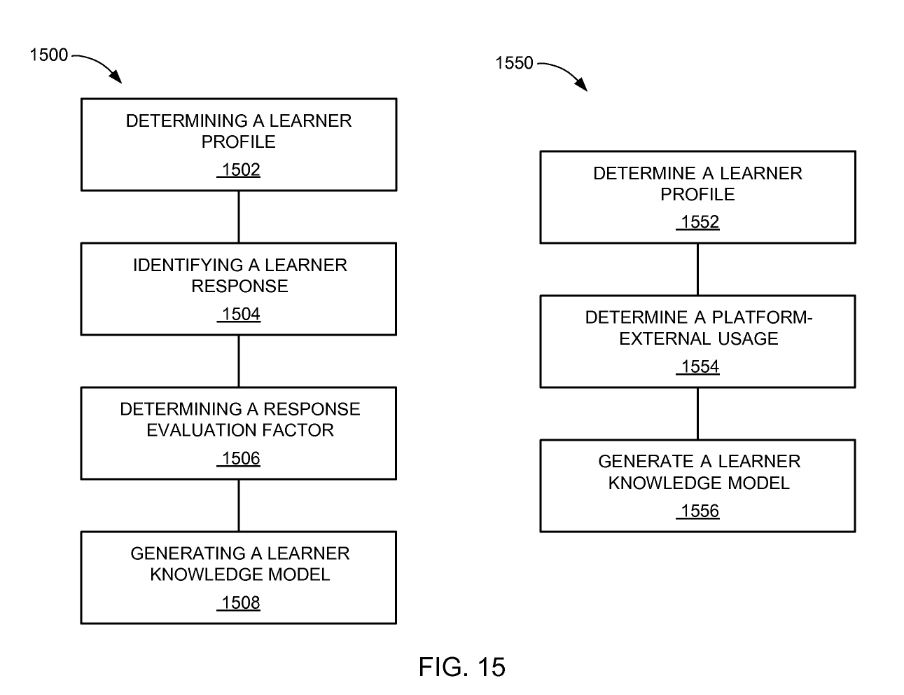

Referring now to FIG. 15, therein is shown a flow chart of a method 1500 and a further flow chart for a further method 1550 of operation of a computing system 100 in a further embodiment of the present invention. The method 1500 includes: determining a learner profile in a block 1502; identifying a learner response for an assessment component for a subject matter corresponding to the learner profile in a block 1504; determining a response evaluation factor associated with the learner response in a block 1506; and generating a learner knowledge model including a mastery level based on the learner response, the response evaluation factor, and the learner profile for displaying on a device in a block 1508.

The method 1550 includes: determining a learner profile associated with a management platform for teaching a subject matter in a block 1552; determining a platform-external usage corresponding the learner profile for characterizing the platform-external usage external to the management platform in a block 1554; and generating a learner knowledge model including a mastery level based on the platform-external usage for displaying on a device in a block 1556.

It has been discovered that the response evaluation factor 222 of FIG. 2 including factors in addition to the answer rate 230 of FIG. 2 provides increased accuracy in understanding the user's knowledge base and proficiency. It has been discovered that the content hook 214 of FIG. 2, the lesson frame 212 of FIG. 2, and the lesson content 216 of FIG. 2 provide customizable delivery of the learning experience.

It has been discovered that the learner knowledge model 322 of FIG. 3 based on various information, including the learner response 220 of FIG. 2, the response evaluation factor 222, and the learner profile 308 of FIG. 3, as described above, provides increased accuracy in understanding the user's knowledge base and proficiency. It has been discovered that the learner profile 308 and the learner knowledge model 322 based on the learning community 330 of FIG. 3 provide individual analysis as well as comparison across various groups sharing similarities.

It has been discovered that the platform-external usage 414 of FIG. 4 and the learner knowledge model 322 provide an accurate estimate of the user's knowledge base and proficiency in the subject matter 204 of FIG. 2. It has been discovered that the subject connection model 348 and the learner knowledge model 322 provide a comprehensive understanding of the user's knowledge base and proficiency.

The physical transformation from the learner knowledge model 322 results in the movement in the physical world, such as change in user's behavior, usage of the first device 102, or movement of the user along with the device. Movement in the physical world results in the response evaluation factor 222, the platform-external usage 414 of FIG. 4, or a combination thereof which can be fed back into the computing system 100 and used to further update the learner knowledge model 322.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a learner analysis module configured to determine a learner profile;
a lesson module, coupled to the learner analysis module, configured to identify a learner response for an assessment component for a subject matter corresponding to the learner profile;
an observation module, coupled to the learner analysis module, configured to determine a response evaluation factor associated with the learner response; and
a knowledge evaluation module, coupled to the observation module, configured to generate a learner knowledge model including a mastery level based on the learner response, the response evaluation factor, and the learner profile for displaying on a device.

2. The system as claimed in claim 1 wherein:
the learner analysis module is configured to determine the learner profile including a learning style, a learner trait, or a combination thereof;
the observation module is configured to determine the response evaluation factor including a component description for identifying a lesson frame, a lesson content, or a combination thereof, an assessment format, a contextual parameter, a physical indication, an error cause estimate, a learner focus level, or a combination thereof associated with the learner response; and
the knowledge evaluation module is configured to generate the learner knowledge model including the mastery level calculated based on the learning style, the learner trait, the lesson frame, the lesson content, the assessment format, the contextual parameter, the physical indication, the error cause estimate, the learner focus level, or a combination thereof.

3. The system as claimed in claim 1 further comprising:
a community module, coupled to the learner analysis module, configured to identify a learning community based on the learner profile, the subject matter, the learner response, the response evaluation factor, the learner knowledge model, or a combination thereof; and
wherein:
the knowledge evaluation module is configured to adjust the learner knowledge model based on the learning community.

4. The system as claimed in claim 1 further comprising:
a community module, coupled to the learner analysis module, configured to identify a common error corresponding to the assessment component; and
wherein:
the knowledge evaluation module is configured to determine the mastery level for the subject matter based on the common error.

5. The system as claimed in claim 1 further comprising:
a community module, coupled to the learner analysis module, configured to identify a common error corresponding to the assessment component; and
a planning module, coupled to the knowledge evaluation module, configured to adjust the assessment component to include the common error for testing the mastery level of the subject matter.

6. The system as claimed in claim 1 further comprising a planning module, coupled to the knowledge evaluation module, configured to generate a practice recommendation based on the learner knowledge model.

7. The system as claimed in claim 1 further comprising a planning module, coupled to the knowledge evaluation module, configured to generate a practice recommendation for the subject matter based the mastery level, the learner profile, the response evaluation factor, or a combination thereof.

8. The system as claimed in claim 1 further comprising:
a subject evaluation module, coupled to the lesson module, configured to determine a subject connection model corresponding to the assessment component;
wherein:
the knowledge evaluation module is configured to generate the learner knowledge model based on the subject connection model.

9. The system as claimed in claim 1 further comprising a reward module, coupled to the lesson module, configured to generate a mastery reward based on the learner knowledge model.

10. The system as claimed in claim 1 further comprising:
a usage detection module, coupled to the learner analysis module, configured to determine a device-usage profile for a platform-external usage for characterizing the platform-external usage of the device and a further device; and
wherein:
the knowledge evaluation module is configured to generate the learner knowledge model based on the device-usage profile.

11. The system as claimed in claim 1 further comprising:
an identification module, coupled to the lesson module, configured to identify a learning session for communicating the assessment component; and
wherein:
the lesson module is configured to adjust a management platform for facilitating the learning session.

12. The system as claimed in claim 11 further comprising:
a frame search module, coupled to the knowledge evaluation module, configured to select a lesson frame based on the learner knowledge model;
a content module, coupled to the frame search module, configured to select a lesson content based on the learner knowledge model; and
a lesson generator module, coupled to the content module, configured to generate the learning session based on combining the lesson frame and the lesson content.

13. The system as claimed in claim 11 further comprising:
a contributor evaluation module, coupled to the observation module, configured to determine an external-entity assessment based on the learner knowledge model for evaluating an external entity associated with the learning session; and
a feedback module, coupled to the contributor evaluation module, configured to communicate the external-entity assessment for informing the external entity associated with the learning session.

14. The system as claimed in claim 11 wherein:
the identification module is configured to identify the learning session including a lesson frame for presenting the assessment component;
further comprising:
a contributor evaluation module, coupled to the observation module, configured to evaluate the lesson frame for the learning session; and
a planning module, coupled to the knowledge evaluation module, configured to generate a frame recommendation based on evaluating the lesson frame.

15. The system as claimed in claim 11 wherein:
the identification module is configured to identify the learning session including a lesson content for representing the subject matter;
further comprising:
a contributor evaluation module, coupled to the observation module, configured to evaluate the lesson content for the learning session; and
a planning module, coupled to the knowledge evaluation module, configured to generate a content recommendation based on evaluating the lesson content.

16. A method of operation of a computing system comprising:
determining a learner profile;
identifying a learner response for an assessment component for a subject matter corresponding to the learner profile;
determining a response evaluation factor associated with the learner response; and
generating a learner knowledge model including a mastery level based on the learner response, the response evaluation factor, and the learner profile for displaying on a device.

17. The method as claimed in claim 16 wherein:
determining the learner profile includes determining the learner profile including a learning style, a learner trait, or a combination thereof; and
determining the response evaluation factor includes determining the response evaluation factor including a component description for identifying a lesson frame, a lesson content, or a combination thereof, an assessment format, a contextual parameter, a physical indication, or a combination thereof associated with the learner response; and
generating the learner knowledge model includes generating the learner knowledge model including the mastery level calculated based on the learning style, the learner trait, the lesson frame, the lesson content, the assessment format, the contextual parameter, the physical indication, or a combination thereof.

18. The method as claimed in claim 16 further comprising:
identifying a learning community based on the learner profile, the subject matter, the learner response, the response evaluation factor, the learner knowledge model, or a combination thereof; and
adjusting the learner knowledge model based on the learning community.

19. The method as claimed in claim 16 further comprising:
identifying a common error corresponding to the assessment component; and
determining the mastery level for the subject matter based on the common error.

20. The method as claimed in claim 16 further comprising:
identifying a common error corresponding to the assessment component;
adjusting the assessment component to include the common error for testing the mastery level of the subject matter.

21. A graphic user interface to exchange dynamic information related to a subject matter, the graphic user interface displayed on an user interface of a device, comprising:
a profile portion configured to display a learner profile;
a lesson portion configured to receive a learner response for an assessment component and receive a response evaluation factor associated with the learner response; and
a knowledge model portion configured to present a learner knowledge model including a mastery level based on updates to the profile portion and the lesson portion.

22. The graphic user interface as claimed in claim 21 further comprising:
a community portion configured to present a learning community based on the learner profile, the subject matter, the learner response, the response evaluation factor, the learner knowledge model, or a combination thereof;
wherein:
the knowledge model portion configured to update the learner knowledge model based on changes in the community portion.

23. The graphic user interface as claimed in claim 21 wherein:
the lesson portion is configured to display a common error corresponding to the assessment component; and
the knowledge model portion configured to update the mastery level for the subject matter based on the common error.

24. The graphic user interface as claimed in claim 21 wherein the knowledge model portion is configured to display a subject connection model corresponding to the assessment component and update the learner knowledge model based on the subject connection model.

25. The graphic user interface as claimed in claim 21 further comprising a reward portion configured to provide a mastery reward based on the learner knowledge model.
